(19) United States
(12) Patent Application Publication
(10) Pub. No.: US 2021/0201478 A1
(43) Pub. Date: Jul. 1, 2021

(54) IMAGE PROCESSING METHODS, ELECTRONIC DEVICES, AND STORAGE MEDIA

(71) Applicant: SenseTime International PTE. LTD., Singapore (SG)

(72) Inventors: Yao ZHANG, Singapore (SG); Shuai ZHANG, Singapore (SG)

(21) Appl. No.: 16/921,169

(22) Filed: Jul. 6, 2020

Related U.S. Application Data
(63) Continuation of application No. PCT/IB2020/050400, filed on Jan. 20, 2020.

(30) Foreign Application Priority Data
Dec. 30, 2019 (SG) 10201913763W

(51) Int. Cl. G06T 7/00; G06T 7/70; G06K 9/00; G06F 9/54

(52) U.S. Cl. CPC G06T 7/0012; G06T 7/70; G06K 9/00335; G06T 2207/30201; G06K 9/00288; G06K 9/00375; G06F 9/542; G06K 9/00268

(57) ABSTRACT

The present disclosure relates to an image processing method and apparatus, an electronic device, and a storage medium. The method includes: detecting an image to be processed to determine multiple target regions in the image to be processed and categories of the multiple target regions, the image to be processed at least comprising a part of a human body and a part of an image on a game table, and the multiple target regions comprising human-related target regions and game-related target regions; performing target recognition on the multiple target regions respectively according to the categories of the multiple target regions, to obtain recognition results of the multiple target regions; and determining association information among the target regions according to the position and/or recognition result of each target region. Embodiments of the present disclosure may implement automatic recognition and association of the target.

### CROSS-REFERENCE TO RELATED APPLICATIONS

The present application is a bypass continuation of and claims priority under 35 U.S.C. § 111(a) to PCT Application. No. PCT/IB2020/050400, filed on Jan. 20, 2020, which claims the priority of the Singapore patent application Ser. No. 10201913763 W, filed Dec. 30, 2019, entitled “IMAGE PROCESSING METHODS AND APPARATUSES, ELECTRONIC DEVICES, AND STORAGE MEDIA”, the entire contents of which are incorporated herein by reference.

### TECHNICAL FIELD

The present disclosure relates to the field of computer technologies, and in particular, to image processing methods and apparatus, electronic devices, and storage media.

### BACKGROUND

Recently, as continuous development of Artificial Intelligence Technology (AIT), the AIT has good effects in aspects such as computer vision and speech recognition. In some relatively special scenes (for example, a desktop game scene), many repeated operations with low technical contents exist. For example, the betting number of the player depends on naked eye identification of the stuff, winning and losing conditions of the player depends on manual statistics of the stuff, etc. The efficiency is low and mistakes would be easily made.

### SUMMARY

The present disclosure provides technical solutions of image processing.

According to an aspect of the present disclosure, an image processing method is provided, including: detecting an image to be processed to determine multiple target regions in the image to be processed and categories of the multiple target regions, the image to be processed at least comprising a part of a human body and a part of an image on a game table, and the multiple target regions comprising human-related target regions and game-related target regions; performing target recognition on the multiple target regions respectively according to the categories of the multiple target regions, to obtain recognition results of the multiple target regions; and determining association information among the target regions according to the position and/or recognition result of each target region.

In a possible implementation, after determining the association information among the target regions, the method further includes: determining whether a human behavior in the image to be processed conforms to a preset behavior rule according to the association information among the target regions; and sending a first prompt message under the condition that the human behavior in the image to be processed does not conform to the preset behavior rule.

In a possible implementation, the human-related target regions include face regions, and the game-related target regions include exchanged object regions;

the detecting the image to be processed to determine the multiple target regions in the image to be processed and the categories of the multiple target regions includes: detecting the image to be processed to determine the face regions and the exchanged object regions in the image to be processed;

the performing the target recognition on the multiple target regions respectively according to the categories of the multiple target regions, to obtain the recognition results of the multiple target regions, includes: performing face key point extraction on the face region, to obtain face key point information of the face region; and determining human identity information corresponding to the face region according to the face key point information; and

the determining the association information among the target regions according to the position and/or recognition result of each target region, includes:

determining the face region associated with each exchanged object region according to the position of each face region and the position of each exchanged object region; and determining respectively human identity information corresponding to the exchanged object region associated with each face region according to the human identity information corresponding to each face region.

In a possible implementation, the determining the face region associated with each exchanged object region according to the position of each face region and the position of each exchanged object region, includes:

under the condition that a distance between a position of a first face region and a position of a first exchanged object region is less than or equal to a first distance threshold, determining that the first face region is associated with the first exchanged object region,

where the first face region is any one of the face regions, and the first exchanged object region is any one of the exchanged object regions.

In a possible implementation, the human-related target regions include face regions and body regions, and the game-related target regions include exchanged object regions;

the detecting the image to be processed to determine the multiple target regions in the image to be processed and the categories of the multiple target regions includes: detecting the image to be processed to determine the face regions, the body regions, and the exchanged object regions in the image to be processed;

the performing the target recognition on the multiple target regions respectively according to the categories of the multiple target regions, to obtain the recognition results of the multiple target regions, includes: performing face key point extraction on the face region, to obtain face key point information of the face region; determining human identity information corresponding to the face region according to the face key point information; and performing body key point extraction on the body region, to obtain body key point information of the body region; and

the determining the association information among the target regions according to the position and/or recognition result of each target region, includes: determining the face region associated with each body region according to the face key point information of each face region and the body key point information of each body region; determining respectively human identity information corresponding to the body region associated with each face region according to the human identity information corresponding to each face region; determining the body region associated with each exchanged object region according to the position of each body region and the position of each exchanged object region; and determining respectively human identity information corresponding to the exchanged object region associated with each body region according to the human identity information corresponding to each body region.

In a possible implementation, the determining the body region associated with each exchanged object region according to the position of each body region and the position of each exchanged object region, includes: under the condition that a distance between a position of a first body region and a position of a second exchanged object region is less than or equal to a second distance threshold, determining that the first body region is associated with the second exchanged object region, where the first body region is any one of the body regions, and the second exchanged object region is any one of the exchanged object regions.

In a possible implementation, the human-related target regions include face regions and hand regions, and the game-related target regions include exchanged object regions;

the detecting the image to be processed to determine the multiple target regions in the image to be processed and the categories of the multiple target regions includes: detecting the image to be processed to determine the face regions, the hand regions, and the exchanged object regions in the image to be processed;

the performing the target recognition on the multiple target regions respectively according to the categories of the multiple target regions, to obtain the recognition results of the multiple target regions, includes: performing face key point extraction on the face region, to obtain face key point information of the face region; and determining human identity information corresponding to the face region according to the face key point information; and

the determining the association information among the target regions according to the position and/or recognition result of each target region, includes: determining the hand region associated with each face region according to the position of each face region and the position of each hand region; determining respectively human identity information corresponding to the hand region associated with each face region according to the human identity information corresponding to each face region; determining the exchanged object region associated with each hand region according to the position of each hand region and the position of each exchanged object region; and determining respectively human identity information corresponding to the exchanged object region associated with each hand region according to the human identity information corresponding to each hand region.

In a possible implementation, the determining the hand region associated with each face region according to the position of each face region and the position of each hand region, includes: under the condition that a distance between a position of a second face region and a position of a first hand region is less than or equal to a third distance threshold, determining that the second face region is associated with the first hand region, where the second face region is any one of the face regions, and the first hand region is any one of the hand regions.

In a possible implementation, the human-related target regions include face regions, body regions, and hand regions, and the game-related target regions include exchanged object regions; the detecting the image to be processed to determine the multiple target regions in the image to be processed and the categories of the multiple target regions includes: detecting the image to be processed to determine the face regions, the body regions, the hand regions, and the exchanged object regions in the image to be processed;

the performing the target recognition on the multiple target regions respectively according to the categories of the multiple target regions, to obtain the recognition results of the multiple target regions, includes: performing face key point extraction on the face region, to obtain face key point information of the face region; determining human identity information corresponding to the face region according to the face key point information; performing body key point extraction on the body region, to obtain body key point information of the body region; and performing hand key point extraction on the hand region, to obtain hand key point information of the hand region; and

the determining the association information among the target regions according to the position and/or recognition result of each target region, includes: determining the face region associated with each body region according to the face key point information of each face region and the body key point information of each body region; determining respectively human identity information corresponding to the body region associated with each face region according to the human identity information corresponding to each face region; determining the body region associated with each hand region according to the body key point information of each body region and the hand key point information of each hand region; determining respectively human identity information corresponding to the hand region associated with each body region according to the human identity information corresponding to each body region; determining the exchanged object region associated with each hand region according to the position of each hand region and the position of each exchanged object region; and determining respectively human identity information corresponding to the exchanged object region associated with each hand region according to the human identity information corresponding to each hand region.

In a possible implementation, the determining the face region associated with each body region according to the face key point information of each face region and the body key point information of each body region, includes: under the condition that an area of an overlapped region between a region where the face key point information of a third face region is located and a region where the body key point information of a second body region is located is greater than or equal to a first area threshold, determining that the third face region is associated with the second body region, where the third face region is any one of the face regions, and the second body region is any one of the body regions.

In a possible implementation, the determining the body region associated with each hand region according to the body key point information of each body region and the hand key point information of each hand region, includes: under the condition that body key point information of a third body region and hand key point information of a second hand region meet a preset condition, determining that the third body region is associated with the second hand region, where the third body region is any one of the body regions, and the second hand region is any one of the hand regions.

In a possible implementation, the preset condition includes at least one of: an area of an overlapped region between a region where the body key point information of the third body region is located and a region where the hand key point information of the second hand region is located is greater than or equal to a second area threshold; a distance between a region where the body key point information of the third body region is located and a region where the hand key point information of the second hand region is located is less than or equal to a fourth distance threshold; and an included angle between a first connection line of the body key point information of the third body region and a second connection line of the hand key point information of the second hand region is less than or equal to an included angle threshold, where the first connection line is a connection line between an elbow key point and a hand key point in the body key point information of the third body region, and the second connection line is a connection line between hand key points in the hand key point information of the second hand region.

In a possible implementation, the determining the exchanged object region associated with each hand region according to the position of each hand region and the position of each exchanged object region, includes: under the condition that a distance between a third hand region and a third exchanged object region is less than or equal to a fifth distance threshold, determining that the third hand region is associated with the third exchanged object region, where the third hand region is any one of the hand regions, and the third exchanged object region is any one of the exchanged object regions.

In a possible implementation, the game-related target regions further include exchanging object regions;

the detecting the image to be processed to determine the multiple target regions in the image to be processed and the categories of the multiple target regions includes: detecting the image to be processed to determine the exchanged object regions and the exchanging object regions in the image to be processed;

the performing the target recognition on the multiple target regions respectively according to the categories of the multiple target regions, to obtain the recognition results of the multiple target regions, includes: performing exchanged object recognition and classification on the exchanged object regions to obtain the position and category of each exchanged object in the exchanged object regions; and performing exchanging object recognition and classification on the exchanging object regions to obtain the category of each exchanging object in the exchanging object regions;

where the method further includes: during an exchanging time period, according to category of each exchanging object in the exchanging object regions, determining a first total value of the exchanging objects in the exchanging object regions; during the exchanging time period, according to the position and category of each exchanged object in the exchanged object regions, determining a second total value of the exchanged objects in the exchanged object regions; and sending a second prompt message under the condition that the first total value is different from the second total value.

In a possible implementation, the game-related target regions further include game playing regions,

the detecting the image to be processed to determine the multiple target regions in the image to be processed and the categories of the multiple target regions includes: detecting the image to be processed, to determine the game playing regions in the image to be processed; and

the performing the target recognition on the multiple target regions respectively according to the categories of the multiple target regions, to obtain the recognition results of the multiple target regions, includes: performing card recognition and classification on the game playing regions, to obtain the position and category of each card in the game playing regions.

In a possible implementation, the method further includes: during a card dealing stage, under the condition that the category of each card in the game playing regions is different from a preset category, sending a third prompt message.

In a possible implementation, the method further includes: during the card dealing stage, under the condition that the position and category of each card in the game playing regions are different from a preset position and a present rule, sending a fourth prompt message.

In a possible implementation, the method further includes: during a settling stage, according to the category of each card in the game playing regions, determining a game result; determining a personal settling rule according to the game result and the position of each personal-related exchanged object region; and determining each personal settling value according to each personal settling rule and a value of the exchanged object in each personal-related exchanged object region.

According to an aspect of the present disclosure, an image processing apparatus is provided, including: a region determining module, configured to detect an image to be processed to determine multiple target regions in the image to be processed and categories of the multiple target regions, the image to be processed at least comprising a part of a human body and a part of an image on a game table, and the multiple target regions comprising human-related target regions and game-related target regions; a target recognizing module, configured to perform target recognition on the multiple target regions respectively according to the categories of the multiple target regions, to obtain recognition results of the multiple target regions; and a region associating module, configured to determine association information among the target regions according to the position and/or recognition result of each target region.

In a possible implementation, after determining the association information among the target regions, the apparatus further includes: a behavior determining module, configured to determine whether a human behavior in the image to be processed conforms to a preset behavior rule according to the association information among the target regions; and a first prompting module, configured to send a first prompt message under the condition that the human behavior in the image to be processed does not conform to the preset behavior rule.

In a possible implementation, the human-related target regions include face regions, and the game-related target regions include exchanged object regions;

the region determining module includes a first determining sub-module, configured to detect the image to be processed to determine the face regions and the exchanged object regions in the image to be processed;

the target recognizing module includes: a first extracting sub-module, configured to perform face key point extraction on the face region, to obtain face key point information of the face region; and a first identity determining sub-module, configured to determine human identity information corresponding to the face region according to the face key point information; and

the region associating module includes: a first associating sub-module, configured to determine the face region associated with each exchanged object region according to the position of each face region and the position of each exchanged object region; and a second identity determining sub-module, configured to determine respectively human identity information corresponding to the exchanged object region associated with each face region according to the human identity information corresponding to each face region.

In a possible implementation, the first associating sub-module is configured to: under the condition that a distance between a position of a first face region and a position of a first exchanged object region is less than or equal to a first distance threshold, determine that the first face region is associated with the first exchanged object region, where the first face region is any one of the face regions, and the first exchanged object region is any one of the exchanged object regions.

In a possible implementation, the human-related target regions include face regions and body regions, and the game-related target regions include exchanged object regions;

the region determining module includes a second determining sub-module, configured to detect the image to be processed to determine the face regions, the body regions, and the exchanged object regions in the image to be processed;

the target recognizing module includes: a first extracting sub-module, configured to perform face key point extraction on the face region, to obtain face key point information of the face region; a first identity determining sub-module, configured to determine human identity information corresponding to the face region according to the face key point information; and a second extracting sub-module, configured to perform body key point extraction on the body region, to obtain body key point information of the body region; and

the region associating module includes: a second associating sub-module, configured to determine the face region associated with each body region according to the face key point information of each face region and the body key point information of each body region; a third identity determining sub-module, configured to determine respectively human identity information corresponding to the body region associated with each face region according to the human identity information corresponding to each face region; a third associating sub-module, configured to determine the body region associated with each exchanged object region according to the position of each body region and the position of each exchanged object region; and a fourth identity determining sub-module, configured to determine respectively human identity information corresponding to the exchanged object region associated with each body region according to the human identity information corresponding to each body region.

In a possible implementation, the third associating sub-module is configured to: under the condition that a distance between a position of a first body region and a position of a second exchanged object region is less than or equal to a second distance threshold, determine that the first body region is associated with the second exchanged object region, where the first body region is any one of the body regions, and the second exchanged object region is any one of the exchanged object regions.

In a possible implementation, the human-related target regions include face regions and hand regions, and the game-related target regions include exchanged object regions;

the region determining module includes a third determining sub-module, configured to detect the image to be processed to determine the face regions, the hand regions, and the exchanged object regions in the image to be processed;

the target recognizing module includes: a first extracting sub-module, configured to perform face key point extraction on the face region, to obtain face key point information of the face region; and a first identity determining sub-module, configured to determine human identity information corresponding to the face region according to the face key point information; and

the region associating module includes: a fourth associating sub-module, configured to determining the hand region associated with each face region according to the position of each face region and the position of each hand region; a fifth identity determining sub-module, configured to determine respectively human identity information corresponding to the hand region associated with each face region according to the human identity information corresponding to each face region; a fifth associating sub-module, configured to determine the exchanged object region associated with each hand region according to the position of each hand region and the position of each exchanged object region; and a sixth identity determining sub-module, configured to determine respectively human identity information corresponding to the exchanged object region associated with each hand region according to the human identity information corresponding to each hand region.

In a possible implementation, the fourth associating sub-module is configured to: under the condition that a distance between a position of a second face region and a position of a first hand region is less than or equal to a third distance threshold, determine that the second face region is associated with the first hand region, where the second face region is any one of the face regions, and the first hand region is any one of the hand regions.

In a possible implementation, the human-related target regions include face regions, body regions, and hand regions, and the game-related target regions include exchanged object regions;

the region determining module includes a fourth determining sub-module, configured to detect the image to be processed to determine the face regions, the body regions, the hand regions, and the exchanged object regions in the image to be processed;

the target recognizing module includes: a first extracting sub-module, configured to perform face key point extraction on the face region, to obtain face key point information of the face region; a first identity determining sub-module, configured to determine human identity information corresponding to the face region according to the face key point information; a second extracting sub-module, configured to perform body key point extraction on the body region, to obtain body key point information of the body region; and a third extracting sub-module, configured to perform hand key point extraction on the hand region, to obtain hand key point information of the hand region; and

the region associating module includes: a second associating sub-module, configured to determine the face region associated with each body region according to the face key point information of each face region and the body key point information of each body region; a third identity determining sub-module, configured to determine respectively human identity information corresponding to the body region associated with each face region according to the human identity information corresponding to each face region; a sixth associating sub-module, configured to determine the body region associated with each hand region according to the body key point information of each body region and the hand key point information of each hand region; a seventh identity determining sub-module, configured to determine respectively human identity information corresponding to the hand region associated with each body region according to the human identity information corresponding to each body region; a fifth associating sub-module, configured to determine the exchanged object region associated with each hand region according to the position of each hand region and the position of each exchanged object region; and a sixth identity determining sub-module, configured to determine respectively human identity information corresponding to the exchanged object region associated with each hand region according to the human identity information corresponding to each hand region.

In a possible implementation, the second associating sub-module is configured to: under the condition that an area of an overlapped region between a region where the face key point information of a third face region is located and a region where the body key point information of a second body region is located is greater than or equal to a first area threshold, determine that the third face region is associated with the second body region, where the third face region is any one of the face regions, and the second body region is any one of the body regions.

In a possible implementation, the sixth associating sub-module is configured to: under the condition that body key point information of a third body region and hand key point information of a second hand region meet a preset condition, determine that the third body region is associated with the second hand region, where the third body region is any one of the body regions, and the second hand region is any one of the hand regions.

In a possible implementation, the preset condition includes at least one of: an area of an overlapped region between a region where the body key point information of the third body region is located and a region where the hand key point information of the second hand region is located is greater than or equal to a second area threshold; a distance between a region where the body key point information of the third body region is located and a region where the hand key point information of the second hand region is located is less than or equal to a fourth distance threshold; and an included angle between a first connection line of the body key point information of the third body region and a second connection line of the hand key point information of the second hand region is less than or equal to an included angle threshold, where the first connection line is a connection line between an elbow key point and a hand key point in the body key point information of the third body region, and the second connection line is a connection line between hand key points in the hand key point information of the second hand region.

In a possible implementation, the fifth associating sub-module is configured to: under the condition that a distance between a third hand region and a third exchanged object region is less than or equal to a fifth distance threshold, determine that the third hand region is associated with the third exchanged object region, where the third hand region is any one of the hand regions, and the third exchanged object region is any one of the exchanged object regions.

In a possible implementation, the game-related target regions further include exchanging object regions;

the region determining module includes a fifth determining sub-module, configured to detect the image to be processed to determine the exchanged object regions and the exchanging object regions in the image to be processed;

the target recognizing module includes: an exchanged object recognizing sub-module, configured to perform exchanged object recognition and classification on the exchanged object regions to obtain the position and category of each exchanged object in the exchanged object regions; and an exchanging object recognizing sub-module, configured to perform exchanging object recognition and classification on the exchanging object regions to obtain the category of each exchanging object in the exchanging object regions; where the apparatus further includes: a first value determining module, configured to, during an exchanging time period, according to the category of each exchanging object in the exchanging object regions, determine a first total value of the exchanging objects in the exchanging object regions; a second value determining module, configured to, during the exchanging time period, according to the position and category of each exchanged object in the exchanged object regions, determine a second total value of the exchanged objects in the exchanged object regions; and a second prompting module, configured to send a second prompt message under the condition that the first total value is different from the second total value.

In a possible implementation, the game-related target regions further include game playing regions,

the region determining module includes a sixth determining sub-module, configured to detect the image to be processed, to determine the game playing regions in the image to be processed; and

the target recognizing module includes a card recognizing sub-module, configured to perform card recognition and classification on the game playing regions, to obtain the position and category of each card in the game playing regions.

In a possible implementation, the apparatus further includes: a third prompting module, configured to, during a card dealing stage, under the condition that the category of each card in the game playing regions is different from a preset category, send a third prompt message.

In a possible implementation, the apparatus further includes: a fourth prompting module, configured to, during the card dealing stage, under the condition that the position and category of each card in the game playing regions are different from a preset position and a present rule, send a fourth prompt message.

In a possible implementation, the apparatus further includes: a result determining module, configured to, during a settling stage, according to the category of each card in the game playing regions, determine a game result; a rule determining module, configured to determine a personal settling rule according to the game result and the position of each personal-related exchanged object region; and a settling value determining module, configured to determine each personal settling value according to each personal settling rule and a value of the exchanged object in each personal-related exchanged object region.

An electronic device provided according to an aspect of the present disclosure includes: a processor; and a memory configured to store processor-executable instructions; where the processor is configured to invoke the instructions stored in the memory to execute the foregoing methods.

A computer-readable storage medium provided according to an aspect of the present disclosure has computer program instructions stored thereon, where when the computer program instructions are executed by a processor, the foregoing methods are implemented.

In the embodiments of the present disclosure, the image region and the category of the region where the target is located in the image can be detected; the identification result of each region is obtained by identifying each region according to the category, so as to determine the association among the regions according to the position and/or identification result of each region, so as to implement automatic identification and association of various targets, reduce human costs, and improve processing efficiency and accuracy.

It should be understood that the above general description and the following detailed description are merely exemplary and explanatory, and are not intended to limit the present disclosure. Exemplary embodiments are described in detail below with reference to the accompanying drawings, and other features and aspects of the present disclosure become clear.

### BRIEF DESCRIPTION OF THE DRAWINGS

The drawings here incorporated in the specification and constituting a part of the specification describe the embodiments of the present disclosure and are intended to explain the technical solutions of the present disclosure together with the specification.

FIG. 1 is a flowchart illustrating an image processing method according to an embodiment of the present disclosure.

FIG. 2 is a schematic diagram of an application scene of an image processing method according to an embodiment of the present disclosure.

FIG. 3a and FIG. 3b illustrate a schematic diagram of body key point information and hand key point information of the image processing method according to an embodiment of the present disclosure.

FIG. 4 is a schematic flowchart of a processing procedure of an image processing method provided according to an embodiment of the present disclosure.

FIG. 5 is a block diagram illustrating an image processing apparatus according to an embodiment of the present disclosure.

FIG. 6 is a block diagram illustrating an electronic device according to an embodiment of the present disclosure.

FIG. 7 is a block diagram illustrating an electronic device according to an embodiment of the present disclosure.

### DETAILED DESCRIPTION

The following will describe various exemplary embodiments, features, and aspects of the present disclosure in detail with reference to the accompanying drawings. Like accompanying symbols in the accompanying drawings represent elements with like or similar functions. Although various aspects of the embodiments are illustrated in the accompanying drawing, the accompanying drawings are not necessarily drawn in proportion unless otherwise specified.

The special term “exemplary” here means “used as an example, an embodiment, or an illustration”. Any embodiment described as “exemplary” here is not necessarily to be interpreted as superior to or better than other embodiments.

The term “and/or” as used herein is merely the association relationship describing the associated objects, indicating that there may be three relationships, for example, A and/or B, which may indicate that A exists separately, and both A and B exist, and B exists separately. In addition, the term “at least one” as used herein means any one of multiple elements or any combination of at least two of the multiple elements, for example, including at least one of A, B, or C, which indicates that any one or more elements selected from a set consisting of A, B, and C are included.

In addition, numerous details are given in the following detailed description for the purpose of better explaining the present disclosure. A person skilled in the art should understand that the present disclosure may also be implemented without some specific details. In some examples, methods, means, elements, and circuits well known to a person skilled in the art are not described in detail so as to highlight the subject matter of the present disclosure.

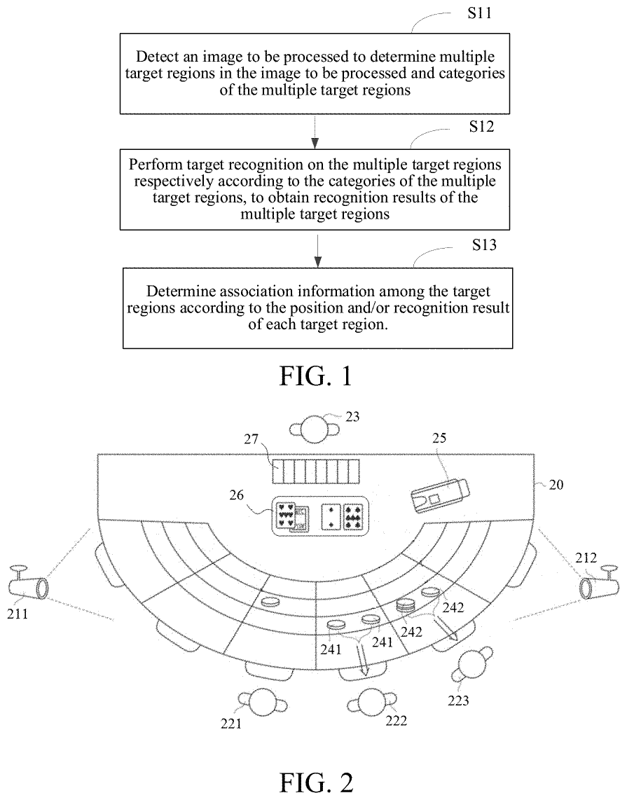

FIG. 1 is a flowchart illustrating an image processing method according to an embodiment of the present disclosure. As shown in FIG. 1, the image processing method includes the following steps:

In step S11, an image to be processed is detected to determine multiple target regions in the image to be processed and categories of the multiple target regions; the image to be processed at least comprises a part of a human body and a part of an image on a game table; the multiple target regions comprises human-related target regions and game-related target regions.

In step S12, target recognition is performed on the multiple target regions respectively according to the categories of the multiple target regions, to obtain recognition results of the multiple target regions.

In step S13, association information among the target regions is determined according to the position and/or recognition result of each target region.

In a possible implementation, the image processing method may be performed by an electronic device such as a terminal device or a server. The terminal device may be a User Equipment (UE), a mobile device, a user terminal, a terminal, a cellular phone, a cordless phone, a Personal Digital Assistant (PDA), a handheld device, a computing device, a vehicle-mounted device, a wearable device, or the like. The method may be implemented by a processor by invoking computer-readable instructions stored in a memory. Or the method may be executed by means of the server.

In a possible implementation, the image to be processed is an image of a monitoring region of a game site collected by an image collection device (for example, a camera). The game site includes one or more monitoring regions (for example, a game table region). Targets requiring to be monitored include personnel such as players and staffs, and also include articles such as exchanged objects (for example, game chips) and exchanging objects (for example, cashes) Images of the monitoring regions are collected by means of the camera (for example, photographing a video stream), and targets in the image (for example, video frames) are analyzed. The present disclosure does not limit the category of the targets requiring to be monitored.

In a possible implementation, for example, cameras may be set at two sides (or multiple sides) of and above the game table region of the game scene, to collect an image of the monitoring region (the two sides of the game table and the desktop of the game table), so that the image to be processed at least includes a part of a human body and a part of the image on the game table; therefore, during the subsequent processing, by means of the image to be processed at the two sides of the game table, a personnel (for example, players and staffs) located adjacent to the game table or an article on the game table (for example, chips) is analyzed; and by means of the image to be processed of the desktop of the game table, articles such as cashes and cards (for example, pokers) are analyzed. In addition, a camera may further be set above the game table to collect an image on the game table in a bird's-eye view. When analyzing the image to be processed, the analysis is performed on the image with the best view of point collected for the purpose of analysis.

FIG. 2 is a schematic diagram of an application scene of an image processing method according to an embodiment of the present disclosure. As shown in FIG. 2, in the game scene, game can be played by means of the game table 20. Images of the game table region are collected by means of cameras 211 and 212 at two sides; players 221, 222, and 223 are located at one side of the game table and the staff 23 is located at the other side of the game table. In the game starting stage, the players may exchange exchanged objects from the staff using the exchanging objects; the staff places the exchanging objects at the exchanging object region 27 for checking, and gives the exchanged objects to the player. During the betting stage, the players place the exchanged objects at a betting region to form multiple exchanged object regions, for example, the exchanged object region 241 of player 222 and the exchanged object region 242 of player 223. During the game playing stage, a dealing device 25 deals the cards to the game playing region 26 to play the game. After the game is finished, the game result may be determined and the settlement may be made according to the card condition of the game playing region 26 in the settling stage.

In a possible implementation, after the image to be processed of each monitoring region is obtained, the image to be processed may be detected in step S11, to determine multiple target regions in the image to be processed and categories of the multiple target regions. The multiple target regions include human-related target regions and game-related target regions. A classifier can be used for detecting the image to be processed and locating the target in the image (for example, players standing by or sitting by the game table, exchanged objects on the game table, etc.), to determine the multiple target regions (detection boxes) and classify the target regions. The classifier may be a deep convolutional neural network; the present disclosure does not limit the network type of the classifier.

In a possible implementation, the human-related target regions include face regions, body regions, hand regions, and the like, and the game-related target regions include exchanged object regions, exchanging object regions, game playing regions, and the like. That is to say, the target regions can be divided into multiple categories, such as faces, bodies, hands, exchanged objects (for example, chips), exchanging objects (for example, cashes), and cards (for example, pokers). The present disclosure does not limit the category range of the target regions.

In a possible implementation, target recognition may be performed on the multiple target regions respectively according to the category of the multiple target regions of the image to be processed, so as to obtain the recognition result of the multiple target regions. For example, according to the position of the image to be processed in each target region (the detection box), the region image of each target region can be captured from the image to be processed; by means of a feature extractor corresponding to the category of the target region, feature extraction is performed on the region image, so as to obtain the feature information of the target region (for example, the face key point feature, the body key point feature, etc.); the feature information of each target region is analyzed (target recognition), so as to obtain the recognition result of each target region. According to the category of the target region, the recognition result may include different contents, for example, including the identity of the figure corresponding to the target region, the number and value of the exchanged objects of the target region, etc.

In a possible implementation, after obtaining the recognition result of each target region, association information among the target regions can be determined according to the position and/or recognition result of the target regions in step S13. According to the relative position among the target regions, for example, the overlapping degree among the target regions, the distance between the target regions, etc., the association information among the target regions can be determined. The association information may be, for example, association between the human identity corresponding to the face region and the human identity corresponding to the body region, association between the human identity corresponding to the hand region and the human identity corresponding to the exchanged object region, etc.

According to the embodiments of the present disclosure, the image region and the category of the region where the target is located in the image can be detected; the recognition result of each region is obtained by recognizing each region according to the category, so as to determine the association among the regions according to the position and/or recognition result of each region, so as to implement automatic recognition and association of various targets, reduce human costs, and improve processing efficiency and accuracy.

In a possible implementation, the image processing method according to the embodiments of the present disclosure can be implemented by means of a neural network; the neural network may include a detection network (a classifier) for determine the multiple target regions in the image to be processed and the category of the multiple target regions. By means of the detection network, the articles (targets) in the image to be processed are located and classified into a certain category.

In a possible implementation, the neural network may further include a target recognition network for performing target recognition on each target region. The corresponding target recognition network (for example, a face recognition network, a body recognition network, a hand recognition network, an exchanged object recognition network, an exchanging object recognition network, a card recognition network, etc.) can be set according to the category of the target region.

In a possible implementation, the human-related target regions include face regions, and the game-related target regions include exchanged object regions.

Step S11 includes: the image to be processed is detected to determine the face regions and the exchanged object regions in the image to be processed.

Step S12 includes: face key point extraction is performed on the face region, to obtain face key point information of the face region; and human identity information corresponding to the face region is determined according to the face key point information.

Step S13 includes: the face region associated with each exchanged object region is determined according to the position of each face region and the position of each exchanged object region; and human identity information corresponding to the exchanged object region associated with each face region is determined respectively according to the human identity information corresponding to each face region.

For example, when detecting the image to be processed, the target regions with the categories of face and exchanged object can be detected; the region images of the face region and the exchanged object region are captured from the image to be processed.

In a possible implementation, for the face region, the region image of the face region can be subjected to face recognition; face key point information in the region image can be extracted (for example, 17 face key points); the face key point information is compared with the face image and/or face feature information of a reference personnel in a database, and the identity of the reference personnel matched with the face key point information is determined as the human identity corresponding to the face region, so as to determine the human identity information. Meanwhile, the face key point information and the identity information can be determined as the recognition result of the face region. For example, if the reference personnel matched with the face key point information of face region A (for example, similarity is greater than or equal to a present similarity threshold) is player M, the face region is determined as the face of player M. In this way, the face feature and identity of the person corresponding to the face region can be determined.

In a possible implementation, during a starting stage, an identity of each face region is determined. For example, if a player approaches the game table and sit down on a seat, it is considered that the player is about to enter the game; the identity of the player is identified and recorded, and then the player is tracked. The present disclosure does not limit the specific timing for determining the identity of the person.

In a possible implementation, the region image of the target region can be processed by means of the face recognition network; upon processing, the recognition result of the target region can be obtained. The face recognition network may be, for example, a deep convolutional neural network, at least including a convolutional layer and a pooling layer (or a softmax layer). The present disclosure does not limit the network type and network structure of the face recognition network.

In a possible implementation, each face region and each exchanged object region can be associated directly in step S13. The face region associated with each exchanged object region can be determined according to the position of each face region and the position of each exchanged object region. Furthermore, according to the association between the face region and the exchanged object region, the human identity information corresponding to each exchanged object region is determined, that is, the human identity information corresponding to the exchanged object region is determined as the human identity information corresponding to the face region associated with the exchanged object region.

In this way, direct association between the face and the exchanged object is implemented to determine the person to whom the exchanged object in each exchanged object region belongs, for example, a player to whom the chip belongs.

In a possible implementation, the step of determining the face region associated with each exchanged object region according to the position of each face region and the position of each exchanged object region, includes:

under the condition that a distance between a position of a first face region and a position of a first exchanged object region is less than or equal to a first distance threshold, determining that the first face region is associated with the first exchanged object region,

where the first face region is any one of the face regions, and the first exchanged object region is any one of the exchanged object regions.

For example, each face region and each exchanged object region are respectively determined. For any face region (referred to as a first face region herein) and any exchanged object region (referred to as a first exchanged object region herein), the distance between the position of the first face region and the position of the first exchanged object region can be calculated, for example, the position between the central point of the first face region and the central point of the first exchanged object region. If the distance is less than or equal to a first distance threshold, it can be determined that the first face region is associated with the first exchanged object region. In this way, the association between the face region and the exchanged object region can be implemented. For example, when a few players are at one game table and sit in a relatively scattered manner, the face can be directly associated with the exchanged object, so as to determine the person to which the exchanged object belongs.

A person skilled in the art can set the first distance threshold according to actual conditions; the present disclosure does not limit the specific value of the first distance value.

In a possible implementation, the human-related target regions include face regions and body regions, and the game-related target regions include exchanged object regions.

Step S11 includes: the image to be processed is detected to determine the face regions, the body region, and the exchanged object regions in the image to be processed.

Step S12 includes: face key point extraction is performed on the face region, to obtain face key point information of the face region; and human identity information corresponding to the face region is determined according to the face key point information;

body key point extraction is performed on the body region, to obtain body key point information of the body region; and

Step S13 includes: the face region associated with each body region is determined according to the face key point information of each face region and the body key point information of each body region; human identity information corresponding to the body region associated with each face region is determined respectively according to the human identity information corresponding to each face region;

the body region associated with each exchanged object region is determined according to the position of each body region and the position of each exchanged object region; and human identity information corresponding to the exchanged object region associated with each body region is determined respectively according to the human identity information corresponding to each body region.

For example, when detecting the image to be processed, the target regions with the categories of face, body, and exchanged object can be detected; the region images of the face region, the body region, and the exchanged object region are captured from the image to be processed.

In a possible implementation, for the face region, the region image of the face region can be subjected to face recognition; face key point information in the region image can be extracted (for example, 17 face key points); the face key point information is compared with the face image and/or face feature information of a reference personnel in a database, and the identity of the reference personnel matched with the face key point information is determined as the human identity corresponding to the face region, so as to determine the human identity information. Meanwhile, the face key point information and the identity information can be determined as the recognition result of the face region. For example, if the reference personnel matched with the face key point information of face region A (for example, similarity is greater than or equal to a present similarity threshold) is player M, the face region is determined as the face of player M. In this way, the face feature and identity of the person corresponding to the face region can be determined.

In a possible implementation, for the body region, body recognition can be performed on the region image of the body region, to extract the body key point information of the region image (for example, 14 body key points of joint parts) and use the body key point information as the recognition result of the body region.

In a possible implementation, the region image of the body region can be processed by means of the body recognition network; upon processing, the recognition result of the body region can be obtained. The body recognition network may be, for example, a deep convolutional neural network. The present disclosure does not limit the network type and network structure of the body recognition network. In this way, the body feature of the person corresponding to the body region can be determined.

In a possible implementation, after obtaining the recognition result of the face region and the body region, the face is associated with the body according to the recognition result of each face region and body region. For example, if an area of an overlapped region between a region where the face key point information of a face region A is located and a region where the body key point information of a body region B is located is exceeds a preset area threshold, it can be considered that the face region A is associated with the body region B, i.e., the face region A and the body region B correspond to the same person (for example, the player). Under this condition, the human identity corresponding to the face region A is determined as the human identity corresponding to the body region B, i.e., the body region B is the body of player M. In this way, the association between the face and the body is implemented, so as to determine the body identity according to the face identity, and improve the efficiency and accuracy of recognition.

In a possible implementation, the step of determining the face region associated with each body region according to the face key point information of each face region and the body key point information of each body region, includes:

under the condition that an area of an overlapped region between a region where the face key point information of a third face region is located and a region where the body key point information of a second body region is located is greater than or equal to a first area threshold, determining that the third face region is associated with the second body region,

wherein the third face region is any one of the face regions, and the second body region is any one of the body regions.

For example, each face region and each body region are respectively determined. For any face region (referred to as a third face region herein) and any one body region (referred to as a second body region herein), an area of an overlapped region between a region where the face key point information of the third face region is located and a region where the body key point information of the second body region is located can be calculated. If the area is less than or equal to a preset first area threshold, it can be determined that the third face region is associated with the second body region. In this way, the association between the face region and the body region can be implemented.

A person skilled in the art can set the first area threshold according to actual conditions; the present disclosure does not limit the specific value of the first area threshold.

In a possible implementation, the body can be associated with the exchanged object. The body region associated with each exchanged object region can be determined according to the position of each body region and the position of each exchanged object region. Furthermore, according to the association between the body region and the exchanged object region, the human identity information corresponding to each exchanged object region is determined, that is, the human identity information corresponding to the exchanged object region is determined as the human identity information corresponding to the body region associated with the exchanged object region.

In this way, association among the face, the body, and the exchanged object is implemented to determine the person to whom the exchanged object in each exchanged object region belongs, for example, a player to whom the chip belongs.

In a possible implementation, the step of determining the body region associated with each exchanged object region according to the position of each body region and the position of each exchanged object region, includes:

under the condition that a distance between a position of a first body region and a position of a second exchanged object region is less than or equal to a second distance threshold, determining that the first body region is associated with the second exchanged object region,

where the first body region is any one of the body regions, and the second exchanged object region is any one of the exchanged object regions.

For example, each body region and each exchanged object region are respectively determined. For any one body region (referred to as a first body region herein) and any exchanged object region (referred to as a second exchanged object region herein), the distance between the position of the first body region and the position of the second exchanged object region can be calculated, for example, the position between the central point of the first body region and the central point of the second exchanged object region. If the distance is less than or equal to a preset second distance threshold, it can be determined that the first body region is associated with the second exchanged object region. In this way, the association between the body region and the exchanged object region can be implemented.

A person skilled in the art can set the second distance threshold according to actual conditions; the present disclosure does not limit the specific value of the second distance value.

In a possible implementation, the human-related target regions include face regions and hand regions, and the game-related target regions include exchanged object regions;

Step S11 includes: the image to be processed is detected to determine the face regions, the hand region, and the exchanged object regions in the image to be processed.

Step S12 includes: face key point extraction is performed on the face region, to obtain face key point information of the face region; and human identity information corresponding to the face region is determined according to the face key point information.

Step S13 includes: the hand region associated with each face region is determined according to the position of each face region and the position of each hand region; and human identity information corresponding to the hand region associated with each face region is determined respectively according to the human identity information corresponding to each face region;

the exchanged object region associated with each hand region is determined according to the position of each hand region and the position of each exchanged object region; and human identity information corresponding to the exchanged object region associated with each hand region is determined respectively according to the human identity information corresponding to each hand region.

For example, when detecting the image to be processed, the target regions with the categories of face, hand, and exchanged object can be detected; the region images of the face region, the hand region, and the exchanged object region are captured from the image to be processed.

In a possible implementation, for the face region, the region image of the face region can be subjected to face recognition; face key point information in the region image can be extracted (for example, 17 face key points); the face key point information is compared with the face image and/or face feature information of a reference personnel in a database, and the identity of the reference personnel matched with the face key point information is determined as the human identity corresponding to the face region, so as to determine the human identity information. Meanwhile, the face key point information and the identity information can be determined as the recognition result of the face region. For example, if the reference personnel matched with the face key point information of face region A (for example, similarity is greater than or equal to a present similarity threshold) is player M, the face region is determined as the face of player M. In this way, the face feature and identity of the person corresponding to the face region can be determined.

In a possible implementation, each face region and each hand region can be associated in step S13. The face region associated with each hand region can be determined according to the position of each face region and the position of each hand region. Furthermore, according to the association between the face region and the hand region, the human identity information corresponding to each hand region is determined, that is, the human identity information corresponding to the hand region is determined as the human identity information corresponding to the face region associated with the hand region. In this way, the human identity corresponding to each hand region can be determined.

In a possible implementation, the step of determining the hand region associated with each face region according to the position of each face region and the position of each hand region, includes:

under the condition that a distance between a position of a second face region and a position of a first hand region is less than or equal to a third distance threshold, determining that the second face region is associated with the first hand region,

where the second face region is any one of the face regions, and the first hand region is any one of the hand regions.

For example, each face region and each hand region are respectively determined. For any face region (referred to as a second face region herein) and any hand region (referred to as a first hand region herein), the distance between the position of the second face region and the position of the first hand region can be calculated, for example, the position between the central point of the second face region and the central point of the first hand region. If the distance is less than or equal to a preset third distance threshold, it can be determined that the second face region is associated with the first hand region. In this way, the association between the face region and the hand region can be implemented.

A person skilled in the art can set the third distance threshold according to actual conditions; the present disclosure does not limit the specific value of the third distance value.

In a possible implementation, each hand region and each exchanged object region can be associated directly in step S13. The hand region associated with each exchanged object region can be determined according to the position of each hand region and the position of each exchanged object region. Furthermore, according to the association between the hand region and the exchanged object region, the human identity information corresponding to each exchanged object region is determined, that is, the human identity information corresponding to the exchanged object region is determined as the human identity information corresponding to the hand region associated with the exchanged object region.

In this way, association among the face, the hand, and the exchanged object is implemented to determine the person to whom the exchanged object in each exchanged object region belongs, for example, a player to whom the chip belongs.

In a possible implementation, the step of determining the exchanged object region associated with each hand region according to the position of each hand region and the position of each exchanged object region, includes:

under the condition that a distance between a third hand region and a third exchanged object region is less than or equal to a fifth distance threshold, determining that the third hand region is associated with the third exchanged object region,

where the third hand region is any one of the hand regions, and the third exchanged object region is any one of the exchanged object regions.

For example, each hand region and each exchanged object region are respectively determined. For any hand region (referred to as a third hand region herein) and any exchanged object region (referred to as a third exchanged object region herein), the distance between the position of the third hand region and the position of the third exchanged object region can be calculated, for example, the position between the central point of the third hand region and the central point of the third exchanged object region. If the distance is less than or equal to a fifth distance threshold, it can be determined that the third hand region is associated with the third exchanged object region. In this way, the association between the hand region and the exchanged object region can be implemented.

A person skilled in the art can set the fifth distance threshold according to actual conditions; the present disclosure does not limit the specific value of the fifth distance value.

In a possible implementation, the human-related target regions include face regions, body regions, and hand regions, and the game-related target regions include exchanged object regions;

Step S11 includes: the image to be processed is detected to determine the face regions, the body region, the hand region, and the exchanged object regions in the image to be processed.

Step S12 includes: face key point extraction is performed on the face region, to obtain face key point information of the face region; and human identity information corresponding to the face region is determined according to the face key point information;

body key point extraction is performed on the body region, to obtain body key point information of the body region; and

hand key point extraction is performed on the hand region, to obtain hand key point information of the hand region.

Step S13 includes: the face region associated with each body region is determined according to the face key point information of each face region and the body key point information of each body region; human identity information corresponding to the body region associated with each face region is determined respectively according to the human identity information corresponding to each face region;

the body region associated with each hand region is determined according to the body key point information of each body region and the hand key point information of each hand region; human identity information corresponding to the hand region associated with each body region is determined respectively according to the human identity information corresponding to each body region; and

the exchanged object region associated with each hand region is determined according to the position of each hand region and the position of each exchanged object region; and human identity information corresponding to the exchanged object region associated with each hand region is determined respectively according to the human identity information corresponding to each hand region.

For example, when detecting the image to be processed, the target regions with the categories of face, body, hand, and exchanged object can be detected; the region images of the face region, the body region, the hand region, and the exchanged object region are captured from the image to be processed.

In a possible implementation, for the face region, the region image of the face region can be subjected to face identification; face key point information in the region image can be extracted (for example, 17 face key points); the face key point information is compared with the face image and/or face feature information of a reference personnel in a database, and the identity of the reference personnel matched with the face key point information is determined as the human identity corresponding to the face region, so as to determine the human identity information. Meanwhile, the face key point information and the identity information can be determined as the identification result of the face region. For example, if the reference personnel matched with the face key point information of face region A (for example, similarity is greater than or equal to a present similarity threshold) is player M, the face region is determined as the face of player M. In this way, the face feature and identity of the person corresponding to the face region can be determined.

In a possible implementation, for the body region, body recognition can be performed on the region image of the body region, to extract the body key point information of the region image (for example, 14 body key points of joint parts) and use the body key point information as the recognition result of the body region. In a possible implementation, the region image of the body region can be processed by means of the body identification network; upon processing, the identification result of the body region can be obtained. The body identification network may be, for example, a deep convolutional neural network. The present disclosure does not limit the network type and network structure of the body identification network. In this way, the body feature of the person corresponding to the body region can be determined.

In a possible implementation, for the hand region, hand recognition can be performed on the region image of the hand region, to extract the hand key point information of the region image (for example, 4 hand key points of joint parts of the hand) and use the hand key point information as the recognition result of the hand region. In a possible implementation, the region image of the hand region can be processed by means of the hand identification network; upon processing, the identification result of the hand region can be obtained. The hand identification network may be, for example, a deep convolutional neural network. The present disclosure does not limit the network type and network structure of the hand identification network. In this way, the hand feature of the person corresponding to the hand region can be determined.

In a possible implementation, after obtaining the recognition result of the face region and the body region, the face is associated with the body according to the recognition result of each face region and body region. For example, if an area of an overlapped region between a region where the face key point information of a face region A is located and a region where the body key point information of a body region B is located is exceeds a preset area threshold, it can be considered that the face region A is associated with the body region B, i.e., the face region A and the body region B correspond to the same person (for example, the player). Under this condition, the human identity corresponding to the face region A is determined as the human identity corresponding to the body region B, i.e., the body region B is the body of player M. In this way, the association between the face and the body is implemented, so as to determine the body identity according to the face identity, and improve the efficiency and accuracy of recognition.

In a possible implementation, after obtaining the recognition result of the body region and the hand region, the body is associated with the hand according to the recognition result of each body region and hand region. For example, if the body key point information of the body region B and the hand key point information of the hand region C meet the preset condition, it can be considered that the body region B is associated with the hand region C, i.e., the body region B and the hand region C correspond to the same person (for example, the player). Under this condition, the human identity corresponding to the body region B is determined as the human identity corresponding to the hand region C, i.e., the hand region C is the hand of player M.

In a possible implementation, the step of determining the body region associated with each hand region according to the body key point information of each body region and the hand key point information of each hand region, includes:

under the condition that body key point information of a third body region and hand key point information of a second hand region meet a preset condition, determining that the third body region is associated with the second hand region,

where the third body region is any one of the body regions, and the second hand region is any one of the hand regions.

For example, each body region and each hand region are respectively determined. For any one body region (referred to as a third body region herein) and any hand region (referred to as a second hand region herein), the relation between the body key point information of the third body region and the hand key point information of the second hand region can be analyzed. If the body key point information of the third body region and the hand key point information of the second hand region meet a preset condition, it can be determined that the third body region is associated with the second hand region.

In a possible implementation, the preset condition may be, for example, if an area of an overlapped region between a region where the body key point information of the body region B is located and a region where the hand key point information of the hand region C is located is greater than or equal to a preset area threshold, the distance between a region where the body key point information of the body region B is located and a region where the hand key point information of the hand region C is located is less than or equal to a preset distance threshold, or an included angle between a first connection line between an elbow key point and a hand key point in the body key points of the body region B and a second connection line between the hand key points of the hand region C is within a preset angle range. The present disclosure does not limit the preset condition for association between the body region and the hand region.

In this way, the association between the body and the hand is implemented, so as to determine the hand identity according to the body identity, and improve the efficiency and accuracy of recognition.

In a possible implementation, the preset condition includes at least one of:

an area of an overlapped region between a region where the body key point information of the third body region is located and a region where the hand key point information of the second hand region is located is greater than or equal to a second area threshold;

a distance between a region where the body key point information of the third body region is located and a region where the hand key point information of the second hand region is located is less than or equal to a fourth distance threshold; and

an included angle between a first connection line of the body key point information of the third body region and a second connection line of the hand key point information of the second hand region is less than or equal to an included angle threshold,

wherein the first connection line is a connection line between an elbow key point and a hand key point in the body key point information of the third body region, and the second connection line is a connection line between hand key points in the hand key point information of the second hand region.

For example, for any one body region (referred to as a third body region herein) and any hand region (referred to as a second hand region herein), the relation between the body key point information of the third body region and the hand key point information of the second hand region can be analyzed.

Under one condition, an area of an overlapped region between a region where the body key point information of the third body region is located and a region where the hand key point information of the second hand region is located can be calculated. If the area is less than or equal to a preset second area threshold, it can be determined that the third body region is associated with the second hand region. A person skilled in the art can set the second area threshold according to actual conditions; the present disclosure does not limit the specific value of the second area threshold.

Under one condition, the distance between the region where the body key point information of the third body region is located and the region where the hand key point information of the second hand region is located can be calculated, for example, the distance between the central point of the third body region and the central point of the second hand region. If the distance is less than or equal to a preset fourth distance threshold, it can be determined that the third body region is associated with the second hand region. A person skilled in the art can set the fourth distance threshold according to actual conditions; the present disclosure does not limit the specific value of the fourth distance threshold.

Under one condition, an included angle between a first connection line of the body key point information of the third body region and a second connection line of the hand key point information of the second hand region can be calculated. The first connection line can be a connection line between an elbow key point and a hand key point in the body key point information of the body region, and the second connection line is a connection line between hand key points in the hand key point information of the hand region. If the included angle is less than or equal to a preset included angle threshold, it can be determined that the third body region is associated with the second hand region. A person skilled in the art can set the included angle threshold according to actual conditions; the present disclosure does not limit the specific value of the included angle threshold.

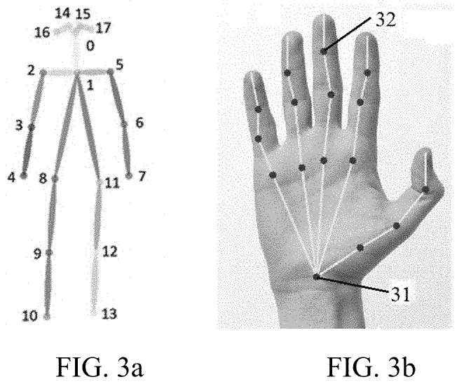

FIG. 3a and FIG. 3b illustrate a schematic diagram of body key point information and hand key point information of the image processing method according to an embodiment of the present disclosure. As shown in FIG. 3a, the body region may include 17 body key points, wherein 3 and 6 are elbow key points, 4 and 7 are hand key points, and the connection line between 3 and 4 and the connection line between 6 and 7 can be sued as the first connection lines. As shown in FIG. 3b, the hand region may include 16 or 21 hand key points, and the connection between the key points 31 and 32 can be used as the second connection line.

It should be understood that FIGS. 3a and 3b are only exemplified examples for the body key point information and the hand key point information; the present disclosure does not limit the specific types of the body key point information and the hand key point information and the selection of the first connection line and the second connection line.

In a possible implementation, the hand and exchanged object regions can be associated in step S13. The hand region associated with each exchanged object region can be determined according to the position of each hand region and the position of each exchanged object region. Furthermore, according to the association between the hand region and the exchanged object region, the human identity information corresponding to each exchanged object region is determined, that is, the human identity information corresponding to the exchanged object region is determined as the human identity information corresponding to the hand region associated with the exchanged object region.

For example, if the distance between the position of the hand region C and the position of the exchanged object region D is less than or equal to a preset distance threshold, it can be considered that the hand region C is associated with the exchanged object region D, i.e., the hand region C and the exchanged object region D correspond to the same person (for example, the player). Under this condition, the person to whom the multiple exchanged objects belong in the exchanged object region D is determined as person M corresponding to the hand region C, for example, the exchanged object in region D is the exchanged object betted by the player M.

In a possible implementation, during the betting stage of the game, each exchanged object region (the betted exchanged object) can be determined, and the player to whom the exchanged object (the exchanged object) of each exchanged object region can be determined. For example, during the betting stage of the game, a player usually places the betted exchanged object on the game table and the hand is distant from the exchanged object during betting. At this moment, the player to whom the multiple exchanged objects belong is determined as the player corresponding to the hand, to implement association between the human and objects. In the follow-up time, the exchange objects are tracked, and if the tracking relation is not changed, the exchanged objects still belong to the player.

In this way, in the mode of cascading the face, body, hand, and exchanged object, the human identity of the exchange object can be determined, so as to improve the success rate and accuracy of recognition.

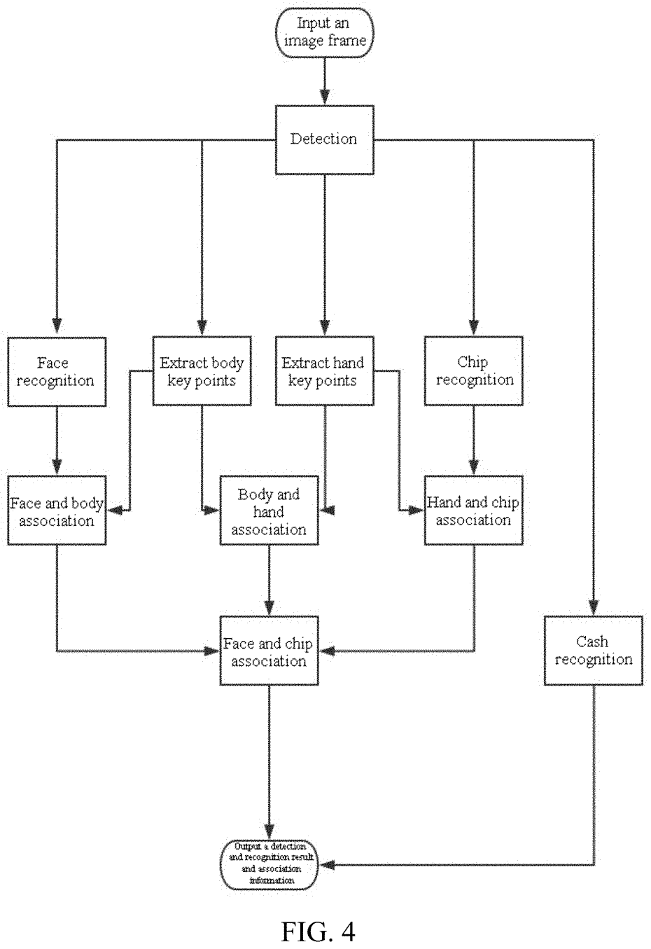

FIG. 4 is a schematic flowchart of a processing procedure of an image processing method provided according to an embodiment of the present disclosure. As shown in FIG. 4, the image frame (the image to be processed) of the monitoring region can be input; the image frame can be detected, to determine multiple target regions and the category of each region, for example, the face, body, hand, exchanged objects (for example, chips), and exchanging objects (for example, chips). The image frame may be images collected by at least one camera disposed at the side of and above the game table at the same moment.

As shown in FIG. 4, the category of each target region can be processed, respectively. For the face region, face recognition can be performed on the image of the region, i.e., extracting the face key point and comparing the face key point with the face image and/or face feature of a reference personnel in a database, and determining the identity of the personnel (for example, the player M) corresponding to the face region.

For the body region, body key points can be extracted from the image of the region and association between the face and the body can be performed according to the face key point of the face region and the body key point of the body region, thereby determining the identity of the personnel corresponding to the body.

For the hand region, hand key points can be extracted from the image of the region and association between the body and the hand can be performed according to the body key point of the body region and the hand key point of the hand region, thereby determining the identity of the personnel corresponding to the hand.

For the exchanged object region, according to the position of the hand region and the position of the exchanged object region, the hand and the exchanged object are associated, so as to implement association between the face and the exchanged object by means of cascading (face-body-hand-exchanged object), to finally determined the identity of the personnel to whom the exchanged object belongs. Moreover, the image of the exchanged object region can be subjected to the exchanged object recognition, i.e., extracting the exchanged object feature of the region image and determining the position and the category of each exchanged object (for example, values).

As shown in FIG. 4, after associating the face and the exchanged object, the recognition result and association information among regions may be output to implement the entire process of the association between the person and object.

In a possible implementation, the game-related target regions further include exchanging object regions;

Step S11 includes: the image to be processed is detected to determine the exchanged object regions and the exchanging object regions in the image to be processed.

Step S12 includes: exchanged object recognition and classification are performed on the exchanged object regions to obtain the position and category of each exchanged object in the exchanged object regions;

exchanging object recognition and classification are performed on the exchanging object regions to obtain the category of each exchanging object in the exchanging object regions;

where the method further includes:

during an exchanging time period, according to category of each exchanging object in the exchanging object regions, determining a first total value of the exchanging objects in the exchanging object regions;

during the exchanging time period, according to the position and category of each exchanged object in the exchanged object regions, determining a second total value of the exchanged objects in the exchanged object regions; and

sending a second prompt message under the condition that the first total value is different from the second total value.

For example, the image to be processed is detected to determine the exchanged object regions and the exchanging object regions in the image to be processed. When it is detected that the category of the target region is the exchanged object (for example, chips), exchanged object recognition can be performed on the region image of the exchanged object region, to extract the feature of each exchanged object of the region image; each exchanged object is divided to determine the position of each exchanged object, thereby determining the category of each exchanged object (the value of the exchanged object, for example 10/20/50/100). The position and category of each exchanged object in the exchanged object region are used as the recognition result of the exchanged object region.

In a possible implementation, the region image of the exchanged object region can be processed by means of the exchanged object identification network; upon processing, the identification result of the exchanged object region can be obtained. The exchanged object identification network may be, for example, a deep convolutional neural network. The present disclosure does not limit the network type and network structure of the exchanged object identification network.

In this way, the position and category of each exchanged object in the exchanged object region can be determined.

In a possible implementation, the game-related target region may further include an exchanging region; the region is placed with exchanging objects (for example, cashes). Before the game starts, an exchanging time period is included; the player may request the staff to exchange the own exchanging objects (for example, cashes) into the exchanged objects. The process may include, for example, the player gives the cashes to the staff; the staff spreads the cashes in a specified region in front of him/her according to a preset rule and determines the total face value of the cashes; then the staff collects the cashes and takes out from a box of the exchanged objects an equivalent amount of exchanged objects and places on the desktop of the game table; then the player checks and collects the exchanged objects.

In a possible implementation, during the time period of exchanging, the image to be processed of the desktop of the game table can be analyzed to determine the exchanging object region in the image to be processed. The image to be processed can be detected by means of the classifier, to locate the target in the image. If the target region is the exchanging object region, the region image of the exchanging region can be captured, to extract the exchanging object feature in the region image, and each exchanging object is divided to determine the position of each exchanging object, thereby determining the category of each exchanging object (the value of cashes, for example, 10/20/50/100 Yuan).

As shown in FIG. 4, cash recognition can be performed on the exchanging object region, i.e., extracting the exchanging object feature in the image of the region and determining the position and category (value) of each cash. The position and category of each exchanging object in the exchanging object region are used as the recognition result of the exchanging object region and the detection recognition result of the exchanging object region is output for follow-up processing.

In a possible implementation, the region image of the exchanging object region can be processed by means of the exchanging object identification network; upon processing, the identification result of the exchanging object region can be obtained. The exchanging object identification network may be, for example, a deep convolutional neural network. The present disclosure does not limit the network type and network structure of the exchanging object identification network.

In this way, the position and category of each exchanging object in the exchanging object region can be recognized for automatically calculating the total value of the exchanging objects in the exchanging object region, assisting the work of the staff, and improving efficiency and accuracy.

In a possible implementation, the embodiments of the present disclosure can assist equal value exchange among objects. During the exchanging time period, the appearance of cashes can be used as a triggering signal, the vanishing of the exchanged object is an ending signal, and the entire process of the period is an equal value exchanging process between the cash and the exchanged object. During the process, when the staff spreads the cashes, the exchanging object region can be detected from the image to be processed (the video frame) and recognition and classification can be performed on each exchanging object in the exchanging object region to determine the position and category of each exchanging object in the exchanging object region.

In a possible implementation, according to the position and category of each exchanging object in the exchanging object regions, a first total value of each exchanging object in the exchanging object region can be calculated. For example, there are three exchanging objects with the face value of 100, and one exchanging object with the face value of 50, and the first total value is 350.

In a possible implementation, when the staff places the exchanged objects with equal value on the desktop of the game table, the exchanged object region in the image to be processed (the video frame) can be detected, and the recognition and classification can be performed on the exchanged object region, to determine the position and category of each exchanged object in the exchanged object region.

In a possible implementation, according to the position and category of each exchanged object in the exchanged object regions, a second total value of the exchanged objects in the exchanged object regions is determined. For example, there are four exchanged objects with the face value of 50, five exchanged objects with the face value of 20, and five exchanged objects with the face value of 10, and the second total value is 350.

In a possible implementation, the first total value is compared with the second total value; if the first and second total values are the same (for example, both 350), no processing is executed; if there is a difference between the first and second total values (for example, the first total value is 350 and the second total value is 370), a prompt message is sent (referred to as second prompt message). The prompt message may include modes such as sounds, images, and vibrations, for example, sounding an alarm, sounding a voice alert, displaying alarm image or text on a corresponding display device, or enabling the vibration of the terminal that can be felt by the staff. The present disclosure does not limit the type of the second prompt message.

In this way, the values of the exchanging object and the exchanged object can be automatically recognized, and the stuff can be prompted to determine and correct when a difference exists between the values of the exchanging object and the exchanged object, so as to avoid mistakes in the exchanging process and improve the operation efficiency and accuracy.

In a possible implementation, the game-related target regions further include game playing regions, where step S11 includes: the image to be processed is detected, to determine the game playing regions in the image to be processed.

Step S12 includes: card recognition and classification are performed on the game playing regions, to obtain the position and category of each card in the game playing regions.

For instance, in related technology, the pokers right dealt by a dealing device is recognized, however, the dealing device has a certain error probability. According to the embodiments of the present disclosure, a game playing region is set in advance on the desktop of the game table, and the game playing region is detected; card recognition is performed on the region image of the region; features of each cards of the region image are extracted, so as to determine the position and category of each card (the card face of the poker, for example, heart 6/diamond 10, etc.). The position and category of each card in the game playing region are used as the recognition result of the game playing region.

In a possible implementation, the region image of the game playing region can be processed by means of the card identification network; upon processing, the identification result of the game playing region can be obtained. The card identification network may be, for example, a deep convolutional neural network. The present disclosure does not limit the network type and network structure of the card identification network.

In this way, the position and category of each card of the game playing region can be automatically determined, so as to improve the efficiency and accuracy of the card recognition.

In a possible implementation, the method further includes: during a card dealing stage, under the condition that the category of each card in the game playing regions is different from a preset category, sending a third prompt message.

For example, the dealing machine may recognize the card just dealt, and determine a preset category of the card; when the card is placed in the game playing region, the image of the game playing region can be recognized to determine the category of the card. If the category of the card is the same as the preset category, no processing is executed; if the category of the card is different from the reset category, the prompt message is sent (referred to third prompt message). The prompt message may include modes such as sounds, images, and vibrations, for example, sounding an alarm, sounding a voice alert, displaying alarm image or text on a corresponding display device, or enabling the vibration of the terminal that can be felt by the staff. The present disclosure does not limit the type of the third prompt message.

In this way, the category of each card of the game playing region can be automatically recognized, and when the category of the card is different from the preset category, the staff is prompted to determine and correct so as to avoid mistakes and improve operation efficiency and accuracy.

In a possible implementation, the method further includes: during the card dealing stage, under the condition that the position and category of each card in the game playing regions are different from a preset position and a present rule, sending a fourth prompt message.

For example, different preset positions in the game playing region may be used for placing cards conforming to the preset rule, for example, the preset rule is dealing in turns to different positions, for example, a first position (for example, a banker) and a second position (for example, a player) in the game playing region, and placing in different preset positions in the game playing region. Under this condition, the image of the game playing region can be recognized to determine the position and category of the card dealt each time. If the position of the card (for example, the player position) is the same as a preset position (for example, the player position), no processing is executed; if the position of the card is different from the preset position, a prompt message is sent (referred to as fourth prompt message). The prompt message may include modes such as sounds, images, and vibrations, for example, sounding an alarm, sounding a voice alert, displaying alarm image or text on a corresponding display device, or enabling the vibration of the terminal that can be felt by the staff. The present disclosure does not limit the type of the fourth prompt message.

In this way, the category of each card of the game playing region can be automatically recognized, and when the position and category of the card are different from the preset position and preset rule of each card, the staff is prompted to determine and correct so as to avoid mistakes and improve operation efficiency and accuracy.

In one possible implementation, the method further includes:

during a settling stage, according to the category of each card in the game playing regions, determining a game result;

determining a personal settling rule according to the game result and the position of each personal-related exchanged object region; and

determining each personal settling value according to each personal settling rule and a value of the exchanged object in each personal-related exchanged object region.

For example, by detecting the image to be processed during the game, the multiple target regions and categories in the image can be determined, the target regions are recognized, and the association among the target regions is determined. In the settling stage after the game is completed, the game result (for example, the first role (e.g., the banker) wins or a second role (e.g., the player) wins) is determined according to the category of each card and the preset game rule in the game playing region.

In a possible implementation, according to the position of the exchanged object region associated with each person (i.e., the player), the betting condition of each player can be determined (for example, betting the first role to win or the second role to win; the game result and the betting condition of each player can be used for determining the settlement rule for each person (for example, 1 for 3). After the settlement rule of each person is determined, each personal settling value is determined according to a value of the exchanged object in each personal-related (i.e., the player) exchanged object region.

In this way, according to the recognition result and association of the regions, the game result is automatically analyzed and the personal settling value is determined, so as to assist the judgment of the staff so as to improve the operation efficiency and accuracy.

In a possible implementation, the method further includes: after determining the association information among the target regions, the method further includes:

determining whether a human behavior in the image to be processed conforms to a preset behavior rule according to the association information among the target regions; and sending a first prompt message under the condition that the human behavior in the image to be processed does not conform to the preset behavior rule.

For example, after determining association information among the target regions, whether each personal behavior (for example, the player) in the image to be processed is a preset behavior rule can further be determined. The preset behavior rule may be, for example, only exchanging the exchanged objects in the exchanging time period, only placing the exchanged object on the game table during the betting stage, etc. If the behavior of the person in the image to be processed does not conform to the preset behavior rule, for example, in the dealing stage after the betting stage, the exchanged object is placed on the game table, and the region where the exchanged object is place is not in a preset placing region, a first prompt message can be sent, so as to prompt the staff to notice.

In this way, the human behavior in the image can be automatically determined, and the staff would be prompted when the behavior does not conform to the preset behavior rule, so as to ensure the game order and improve the operation efficiency and accuracy.

In a possible implementation, before deploying a neural network to process the image, the neural network is trained. According to the embodiments of the present disclosure, the method further includes:

according to a preset training set, training the neural network, and the training set including multiple annotated sample images

For example, multiple monitoring images of the monitoring region of the target scene can be obtained and the target to be recognized in each image is annotated, for example, the image box of positions of the face, body, and hand of a person (for example, the player or the staff) neighboring the game table, the image box of the article (for example, the exchanged object) on the game table are annotated; the category attributes of each image box (the face, body, hand, exchanged object, card, etc.) and attributes of each object in the image boxes (for example, the position, type and face value of each exchanged object) are respectively annotated. After annotation, annotated data may be converted into special codes.

In a possible implementation, the multiple annotated images may be used as samples to constitute a training set; the codes after converting the annotated data are monitoring signals for training a training network (the detection network and target recognition network). The detection network and each sub-network (the face recognition network, body recognition network, hand recognition network, exchanged object recognition network, exchanging object recognition network, card recognition network, etc.) of the target recognition network are respectively trained and can also be trained at the same time. After multiple times of training and iteration, the stable and available neural network that meets the precision requirement can be obtained. The present disclosure does not limit the specific training mode of the neural network.

According to the embodiments of the present disclosure, it can be applied to the scene such as desktop game to assist to complete the game process. For example, before the game starts, after the player sits down, the identity can be determined according to face information of each player (face swiping input), which represents the player is about to join the game; some players without the exchanged objects can exchange the exchanging objects for the exchanged objects; at this time, an algorithm is enabled to respectively recognize the exchanging objects of the player and the exchanged objects placed by the staff (a dealer) and verify whether the two parties have an equal value; if they are unequal values, the staff is prompted to calculate again; after the exchanging of the exchanged objects ends, the players make a betting; different persons bet in regions of different loss percent; the algorithm detects how many exchanged objects are bet in each region; by means of the association algorithm of each region, which player bets each pile of exchanged objects is determined; after the betting ends, the staff starts to deal, recognize and determine the type of each poker card by means of card recognition, and automatically calculate winning or losing automatically. When entering the settling stage, the staff takes out a certain amount of exchanged objects according to the loss percent; the system calculates whether they are equal values according to the loss percent and the amount of the exchanged objects betted by the player; this game ends after settlement is done.

According to the embodiments of the present disclosure, an end-to-end game assistant function can be implemented; recognition of human and desktop object can be executed, including cards, exchanging objects, and exchanged objects, which greatly reduces the manpower for calculation of the staff, reduces error probability, and improves efficiency; no excess cooperative requirement is required for the player and the staff, and experiences for the related personnel would not be affected.

According to the embodiments of the present disclosure, by using a deeply studied technique, the detection and recognition effects are better, more complex scenes can be handled, and more adaptive for the environment, and better robustness are included; object exchanging can be recognized by combining content information of the scenes (the player takes out the exchanging object and the staff gives the exchanged object after checking), so as to further reduce the error probability.

It can be understood that the foregoing method embodiments mentioned in the present disclosure are combined with each other to form a combined embodiment without departing from the principle and the logic. Details are not described in the present disclosure due to space limitation. person skilled in the art should understand that in the method above in the specific embodiments, a specific execution sequence of the steps should be determined according to functions and inner logic thereof.

In addition, the present disclosure further provides an image processing apparatus, an electronic device, a computer readable storage medium, and a program. The foregoing are all used to implement any image processing method provided in the present disclosure. For corresponding technical solutions and descriptions, refer to corresponding descriptions of the method. Details are not described again.

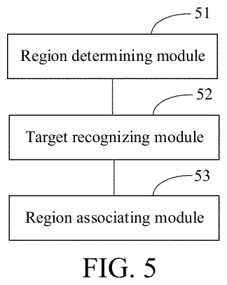

FIG. 5 is a block diagram illustrating an image processing apparatus according to embodiments of the present disclosure. As shown in FIG. 5, the image processing apparatus includes:

a region determining module 51, configured to detect an image to be processed to determine multiple target regions in the image to be processed and categories of the multiple target regions, the image to be processed at least comprising a part of a human body and a part of an image on a game table, and the multiple target regions comprising human-related target regions and game-related target regions; a target recognizing module 52, configured to perform target recognition on the multiple target regions respectively according to the categories of the multiple target regions, to obtain recognition results of the multiple target regions; and a region associating module 53, configured to determine association information among the target regions according to the position and/or recognition result of each target region.

In a possible implementation, after determining the association information among the target regions, the apparatus further includes: a behavior determining module, configured to determine whether a human behavior in the image to be processed conforms to a preset behavior rule according to the association information among the target regions; and a first prompting module, configured to send a first prompt message under the condition that the human behavior in the image to be processed does not conform to the preset behavior rule.

In a possible implementation, the human-related target regions include face regions, and the game-related target regions include exchanged object regions;

the region determining module includes a first determining sub-module, configured to detect the image to be processed to determine the face regions and the exchanged object regions in the image to be processed;

the target recognizing module includes: a first extracting sub-module, configured to perform face key point extraction on the face region, to obtain face key point information of the face region; and a first identity determining sub-module, configured to determine human identity information corresponding to the face region according to the face key point information; and

the region associating module includes: a first associating sub-module, configured to determine the face region associated with each exchanged object region according to the position of each face region and the position of each exchanged object region; and a second identity determining sub-module, configured to determine respectively human identity information corresponding to the exchanged object region associated with each face region according to the human identity information corresponding to each face region.

In a possible implementation, the first associating sub-module is configured to: under the condition that a distance between a position of a first face region and a position of a first exchanged object region is less than or equal to a first distance threshold, determine that the first face region is associated with the first exchanged object region, where the first face region is any one of the face regions, and the first exchanged object region is any one of the exchanged object regions.

In a possible implementation, the human-related target regions include face regions and body regions, and the game-related target regions include exchanged object regions;

the region determining module includes a second determining sub-module, configured to detect the image to be processed to determine the face regions, the body regions, and the exchanged object regions in the image to be processed;

the target recognizing module includes: a first extracting sub-module, configured to perform face key point extraction on the face region, to obtain face key point information of the face region; a first identity determining sub-module, configured to determine human identity information corresponding to the face region according to the face key point information; and a second extracting sub-module, configured to perform body key point extraction on the body region, to obtain body key point information of the body region; and

the region associating module includes: a second associating sub-module, configured to determine the face region associated with each body region according to the face key point information of each face region and the body key point information of each body region; a third identity determining sub-module, configured to determine respectively human identity information corresponding to the body region associated with each face region according to the human identity information corresponding to each face region; a third associating sub-module, configured to determine the body region associated with each exchanged object region according to the position of each body region and the position of each exchanged object region; and a fourth identity determining sub-module, configured to determine respectively human identity information corresponding to the exchanged object region associated with each body region according to the human identity information corresponding to each body region.

In a possible implementation, the third associating sub-module is configured to: under the condition that a distance between a position of a first body region and a position of a second exchanged object region is less than or equal to a second distance threshold, determine that the first body region is associated with the second exchanged object region, where the first body region is any one of the body regions, and the second exchanged object region is any one of the exchanged object regions.

In a possible implementation, the human-related target regions include face regions and hand regions, and the game-related target regions include exchanged object regions;

the region determining module includes a third determining sub-module, configured to detect the image to be processed to determine the face regions, the hand regions, and the exchanged object regions in the image to be processed;

the target recognizing module includes: a first extracting sub-module, configured to perform face key point extraction on the face region, to obtain face key point information of the face region; and a first identity determining sub-module, configured to determine human identity information corresponding to the face region according to the face key point information; and

the region associating module includes: a fourth associating sub-module, configured to determining the hand region associated with each face region according to the position of each face region and the position of each hand region; a fifth identity determining sub-module, configured to determine respectively human identity information corresponding to the hand region associated with each face region according to the human identity information corresponding to each face region; a fifth associating sub-module, configured to determine the exchanged object region associated with each hand region according to the position of each hand region and the position of each exchanged object region; and a sixth identity determining sub-module, configured to determine respectively human identity information corresponding to the exchanged object region associated with each hand region according to the human identity information corresponding to each hand region.

In a possible implementation, the fourth associating sub-module is configured to: under the condition that a distance between a position of a second face region and a position of a first hand region is less than or equal to a third distance threshold, determine that the second face region is associated with the first hand region, where the second face region is any one of the face regions, and the first hand region is any one of the hand regions.

In a possible implementation, the human-related target regions include face regions, body regions, and hand regions, and the game-related target regions include exchanged object regions;

the region determining module includes a fourth determining sub-module, configured to detect the image to be processed to determine the face regions, the body regions, the hand regions, and the exchanged object regions in the image to be processed;

the target recognizing module includes: a first extracting sub-module, configured to perform face key point extraction on the face region, to obtain face key point information of the face region; a first identity determining sub-module, configured to determine human identity information corresponding to the face region according to the face key point information; a second extracting sub-module, configured to perform body key point extraction on the body region, to obtain body key point information of the body region; and a third extracting sub-module, configured to perform hand key point extraction on the hand region, to obtain hand key point information of the hand region; and

the region associating module includes: a second associating sub-module, configured to determine the face region associated with each body region according to the face key point information of each face region and the body key point information of each body region; a third identity determining sub-module, configured to determine respectively human identity information corresponding to the body region associated with each face region according to the human identity information corresponding to each face region; a sixth associating sub-module, configured to determine the body region associated with each hand region according to the body key point information of each body region and the hand key point information of each hand region; a seventh identity determining sub-module, configured to determine respectively human identity information corresponding to the hand region associated with each body region according to the human identity information corresponding to each body region; a fifth associating sub-module, configured to determine the exchanged object region associated with each hand region according to the position of each hand region and the position of each exchanged object region; and a sixth identity determining sub-module, configured to determine respectively human identity information corresponding to the exchanged object region associated with each hand region according to the human identity information corresponding to each hand region.

In a possible implementation, the second associating sub-module is configured to: under the condition that an area of an overlapped region between a region where the face key point information of a third face region is located and a region where the body key point information of a second body region is located is greater than or equal to a first area threshold, determine that the third face region is associated with the second body region, where the third face region is any one of the face regions, and the second body region is any one of the body regions.

In a possible implementation, the sixth associating sub-module is configured to: under the condition that body key point information of a third body region and hand key point information of a second hand region meet a preset condition, determine that the third body region is associated with the second hand region, where the third body region is any one of the body regions, and the second hand region is any one of the hand regions.

In a possible implementation, the preset condition includes at least one of: an area of an overlapped region between a region where the body key point information of the third body region is located and a region where the hand key point information of the second hand region is located is greater than or equal to a second area threshold; a distance between a region where the body key point information of the third body region is located and a region where the hand key point information of the second hand region is located is less than or equal to a fourth distance threshold; and an included angle between a first connection line of the body key point information of the third body region and a second connection line of the hand key point information of the second hand region is less than or equal to an included angle threshold, where the first connection line is a connection line between an elbow key point and a hand key point in the body key point information of the third body region, and the second connection line is a connection line between hand key points in the hand key point information of the second hand region.

In a possible implementation, the fifth associating sub-module is configured to: under the condition that a distance between a third hand region and a third exchanged object region is less than or equal to a fifth distance threshold, determine that the third hand region is associated with the third exchanged object region, where the third hand region is any one of the hand regions, and the third exchanged object region is any one of the exchanged object regions.

In a possible implementation, the game-related target regions further include exchanging object regions;

the region determining module includes a fifth determining sub-module, configured to detect the image to be processed to determine the exchanged object regions and the exchanging object regions in the image to be processed;

the target recognizing module includes: an exchanged object recognizing sub-module, configured to perform exchanged object recognition and classification on the exchanged object regions to obtain the position and category of each exchanged object in the exchanged object regions; and an exchanging object recognizing sub-module, configured to perform exchanging object recognition and classification on the exchanging object regions to obtain the category of each exchanging object in the exchanging object regions; where the apparatus further includes: a first value determining module, configured to, during an exchanging time period, according to the category of each exchanging object in the exchanging regions, determine a first total value of the exchanging objects in the exchanging object regions; a second value determining module, configured to, during the exchanging time period, according to the position and category of each exchanged object in the exchanged regions, determining a second total value of the exchanged objects in the exchanged object regions; and a second prompting module, configured to send a second prompt message under the condition that the first total value is different from the second total value.

In a possible implementation, the game-related target regions further include game playing regions,

the region determining module includes a sixth determining sub-module, configured to detect the image to be processed, to determine the game playing regions in the image to be processed; and

the target recognizing module includes a card recognizing sub-module, configured to perform card recognition and classification on the game playing regions, to obtain the position and category of each card in the game playing regions.

In a possible implementation, the apparatus further includes: a third prompting module, configured to, during a card dealing stage, under the condition that the category of each card in the game playing regions is different from a preset category, send a third prompt message.

In a possible implementation, the apparatus further includes: a fourth prompting module, configured to, during the card dealing stage, under the condition that the position and category of each card in the game playing regions are different from a preset position and a present rule, send a fourth prompt message.

In a possible implementation, the apparatus further includes: a result determining module, configured to, during a settling stage, according to the category of each card in the game playing regions, determine a game result; a rule determining module, configured to determine a personal settling rule according to the game result and the position of each personal-related exchanged object region; and a settling value determining module, configured to determine each personal settling value according to each personal settling rule and a value of the exchanged object in each personal-related exchanged object region.

In some embodiments, the functions provided by or the modules included in the apparatuses provided by the embodiments of the present disclosure may be used to implement the methods described in the foregoing method embodiments. For specific implementations, reference may be made to the description in the method embodiments above. For the purpose of brevity, details are not described herein again.

The embodiments of the present disclosure further provide a computer-readable storage medium, having computer program instructions stored thereon, where when the computer program instructions are executed by a processor, the foregoing methods are implemented. The computer readable storage medium may be a non-volatile computer readable storage medium.

An electronic device further provided according to the embodiments of the present disclosure includes: a processor; and a memory configured to store processor-executable instructions; where the processor is configured to invoke the instructions stored in the memory to execute the foregoing methods.

The electronic device may be provided as a terminal, a server, or other forms of devices.

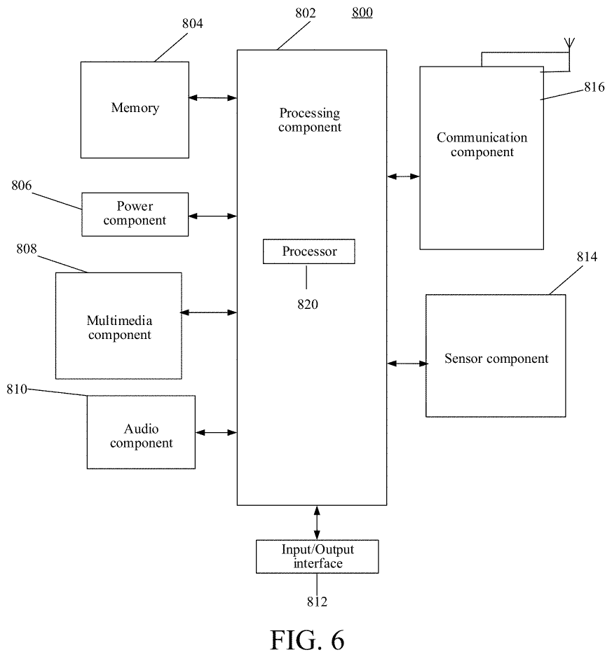

FIG. 6 is a block diagram illustrating an electronic device 800 according to an embodiment of the present disclosure. For example, the electronic device 800 may be a terminal such as a mobile phone, a computer, a digital broadcast terminal, a message transceiver device, a game console, a tablet device, a medical device, exercise equipment, and a personal digital assistant.

With reference to FIG. 6, the electronic device 800 may include one or more of the following components: a processing component 802, a memory 804, a power supply component 806, a multimedia component 808, an audio component 810, an Input/Output (I/O) interface 812, a sensor component 814, and a communication component 816.

The processing component 802 generally controls overall operation of the electronic device 800, such as operations associated with display, phone calls, data communications, camera operations, and recording operations. The processing component 802 may include one or more processors 820 to execute an instruction, to complete all or some of the steps of the foregoing method. In addition, the processing component 802 may include one or more modules, to facilitate interaction between the processing component 802 and other components. For example, the processing component 802 includes a multimedia module, to facilitate interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, and etc. The memory 804 is implemented by any type of volatile or non-volatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disc.

The power component 806 provides power for various components of the electronic device 800. The power component 806 may include a power management system, one or more power supplies, and other components associated with power generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes the touch panel, the screen is implemented as a touchscreen, to receive an input signal from the user. The touch panel includes one or more touch sensors to sense a touch, a slide, and a gesture on the touch panel. The touch sensor may not only sense a boundary of a touch action or a slide action, but also detect the duration and pressure related to the touch operation or the slide operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. Each front-facing camera or rear-facing camera is a fixed optical lens system or has a focal length and an optical zoom capability.

The audio component 810 is configured to output and/or input an audio signal. For example, the audio component 810 includes a microphone (MIC), and the microphone is configured to receive an external audio signal when the electronic device 800 is in an operation mode, such as a calling mode, a recording mode, and a voice recognition mode. The received audio signal is further stored in the memory 804 or sent by means of the communications component 816. In some embodiments, the audio component 810 further includes a speaker, configured to output an audio signal.

The I/O interface 812 provides an interface between the processing component 802 and a peripheral interface module, and the peripheral interface module is a keyboard, a click wheel, a button, or the like. These buttons may include but are not limited to a home button, a volume button, a startup button, and a lock button.

The sensor component 814 includes one or more sensors for providing state assessment in various aspects for the electronic device 800. For example, the sensor component 814 may detect an on/off state of the electronic device 800, and relative positioning of components, which are the display and keypad of the electronic device 800, for example, and the sensor component 814 may further detect a position change of the electronic device 800 or a component of the electronic device 800, the presence or absence of contact of the user with the electronic device 800, the orientation or acceleration/deceleration of the electronic device 800, and a temperature change of the electronic device 800. The sensor component 814 may include a proximity sensor, configured to detect existence of a nearby object when there is no physical contact. The sensor component 814 may further include an optical sensor, such as a CMOS or CCD image sensor, configured for use in an imaging application. In some embodiments, the sensor component 814 may further include an acceleration sensor, a gyro sensor, a magnetic sensor, a pressure sensor, or a temperature sensor.

The communication component 816 is configured to facilitate wired or wireless communications between the electronic device 800 and other devices. The electronic device 800 may access a wireless network based on a communication standard, such as WiFi, 2G, or 3G, or a combination thereof. In one exemplary embodiment, the communication component 816 receives a broadcast signal or broadcast-related information from an external broadcast management system by means of a broadcast channel. In one exemplary embodiment, the communication component 816 further includes a Near Field Communication (NFC) module to facilitate short-range communication. For example, the NFC module may be implemented based on Radio Frequency Recognition (RFID) technology, Infrared Data Association (IrDA) technology, Ultra-Wideband (UWB) technology, Bluetooth (BT) technology, and other technologies.

In an exemplary embodiment, the electronic device 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the method above.

In an exemplary embodiment, further provided is a non-volatile computer-readable storage medium, for example, a memory 804 including computer program instructions, which can executed by the processor 820 of the electronic device 800 to implement the methods above.

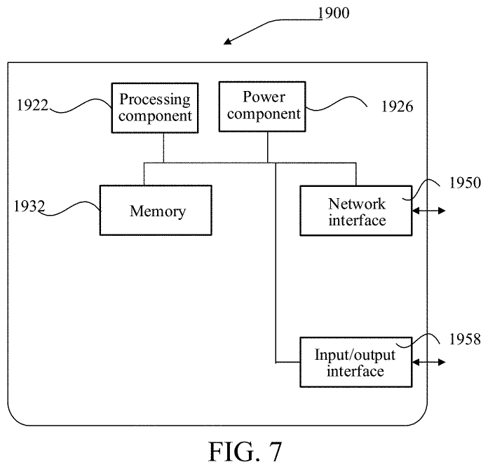

FIG. 7 is a block diagram illustrating an electronic device 1900 according to an embodiment of the present disclosure. For example, the electronic device 1900 may be provided as a server. With reference to FIG. 7, the electronic device 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. In addition, the processing component 1922 may be configured to execute instructions so as to execute the methods above.

The electronic device 1900 may further include a power component 1926 configured to execute power management of the electronic device 1900, a wired or wireless network interface 1950 configured to connect the electronic device 1900 to the network, and an I/O interface 1958. The electronic device 1900 may be operated based on an operating system stored in the memory 1932, such as Windows Server, Mac OS X™ Unix™, Linux™, FreeBSD™ or the like.

In an exemplary embodiment, further provided is a non-volatile computer-readable storage medium, for example, a memory 1932 including computer program instructions, which can executed by the processing component 1922 of the electronic device 1900 to implement the methods above.

The present disclosure may be a system, a method, and/or a computer program product. The computer program product may include a computer-readable storage medium, on which computer-readable program instructions used by the processor to implement various aspects of the present disclosure are stored.

The computer-readable storage medium may be a tangible device that can maintain and store instructions used by an instruction execution device. The computer-readable storage medium may be, but is not limited to, an electronic storage device, a magnetic storage device, an optical storage device, an electromagnetic storage device, a semiconductor storage device, or any suitable combination of the foregoing. More specific examples (a non-exhaustive list) of the computer readable storage medium include a portable computer disk, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanical coding device such as a punched card storing an instruction or a protrusion structure in a groove, and any appropriate combination thereof. The computer-readable storage medium used herein is not interpreted as an instantaneous signal such as a radio wave or other freely propagated electromagnetic wave, an electromagnetic wave propagated by a waveguide or other transmission media (for example, an optical pulse transmitted by an optical fiber cable), or an electrical signal transmitted by a wire.

The computer-readable program instruction described here is downloaded from a computer readable storage medium to each computing/processing device, or downloaded to an external computer or an external storage device via a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or a network interface in each computing/processing device receives the computer readable program instruction from the network, and forwards the computer readable program instruction, so that the computer readable program instruction is stored in a computer readable storage medium in each computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The program-readable program instructions can be completely executed on a user computer, partially executed on a user computer, executed as an independent software package, executed partially on a user computer and partially on a remote computer, or completely executed on a remote computer or a server. In the case of a remote computer, the remote computer may be connected to a user computer via any type of network, including a Local Area Network (LAN) or a Wide Area Network (WAN), or may be connected to an external computer (for example, connected via the Internet with the aid of an Internet service provider). In some embodiments, an electronic circuit such as a programmable logic circuit, a Field Programmable Gate Array (FPGA), or a Programmable Logic Array (PLA) is personalized by using status information of the computer-readable program instructions, and the electronic circuit can execute the computer-readable program instructions to implement various aspects of the present disclosure.

Various aspects of the present disclosure are described here with reference to the flowcharts and/or block diagrams of the methods, apparatuses (systems), and computer program products according to the embodiments of the present disclosure. It should be understood that each block in the flowcharts and/or block diagrams and a combination of the blocks in the flowcharts and/or block diagrams can be implemented with the computer readable program instructions.

These computer readable program instructions may be provided for a general-purpose computer, a dedicated computer, or a processor of another programmable data processing apparatus to generate a machine, so that when the instructions are executed by the computer or the processors of other programmable data processing apparatuses, an apparatus for implementing a specified function/action in one or more blocks in the flowcharts and/or block diagrams is generated. These computer readable program instructions may also be stored in a computer readable storage medium, and these instructions instruct a computer, a programmable data processing apparatus, and/or other devices to work in a specific manner. Therefore, the computer readable storage medium having the instructions stored thereon includes a manufacture, and the manufacture includes instructions for implementing specified functions/actions in one or more blocks in the flowcharts and/or block diagrams.

The computer readable program instructions may also be loaded onto a computer, other programmable data processing apparatuses, or other devices, so that a series of operations and steps are executed on the computer, the other programmable apparatuses, or the other devices, thereby generating computer-implemented processes. Therefore, the instructions executed on the computer, the other programmable apparatuses, or the other devices implement the specified functions/actions in the one or more blocks in the flowcharts and/or block diagrams.

The flowcharts and block diagrams in the accompanying drawings show architectures, functions, and operations that may be implemented by the systems, methods, and computer program products in the embodiments of the present disclosure. In this regard, each block in the flowcharts or block diagrams may represent a module, a program segment, or a part of instruction, and the module, the program segment, or the part of instruction includes one or more executable instructions for implementing a specified logical function. In some alternative implementations, functions marked in the block may also occur in an order different from that marked in the accompanying drawings. For example, two consecutive blocks are actually executed substantially in parallel, or are sometimes executed in a reverse order, depending on the involved functions. It should also be noted that each block in the block diagrams and/or flowcharts and a combination of blocks in the block diagrams and/or flowcharts may be implemented by using a dedicated hardware-based system configured to execute specified functions or actions, or may be implemented by using a combination of dedicated hardware and computer instructions.

The embodiments of the present disclosure are described above. The foregoing descriptions are exemplary but not exhaustive, and are not limited to the disclosed embodiments. For a person of ordinary skill in the art, many modifications and variations are all obvious without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

1. An image processing method, comprising:
detecting an image to be processed to determine multiple target regions in the image to be processed and categories of the multiple target regions, the image to be processed at least comprising a part of a human body and a part of an image on a game table, and the multiple target regions comprising human-related target regions and game-related target regions;
performing target recognition on the multiple target regions respectively according to the categories of the multiple target regions, to obtain recognition results of the multiple target regions; and
determining association information among the target regions according to the position and/or recognition result of each target region.

2. The method according to claim 1, wherein after determining the association information among the target regions, the method further comprises:
determining whether a human behavior in the image to be processed conforms to a preset behavior rule according to the association information among the target regions; and
sending a first prompt message under the condition that the human behavior in the image to be processed does not conform to the preset behavior rule.

3. The method according to claim 1, wherein the human-related target regions comprise face regions, and the game-related target regions comprise exchanged object regions;
detecting the image to be processed to determine the multiple target regions in the image to be processed and the categories of the multiple target regions comprises:
detecting the image to be processed to determine the face regions and the exchanged object regions in the image to be processed;
performing the target recognition on the multiple target regions respectively according to the categories of the multiple target regions, to obtain the recognition results of the multiple target regions, comprises:
performing face key point extraction on the face region, to obtain face key point information of the face region; and
determining human identity information corresponding to the face region according to the face key point information; and
determining the association information among the target regions according to the position and/or recognition result of each target region, comprises:
determining the face region associated with each exchanged object region according to the position of each face region and the position of each exchanged object region; and
determining respectively human identity information corresponding to the exchanged object region associated with each face region according to the human identity information corresponding to each face region.

4. The method according to claim 3, wherein determining the face region associated with each exchanged object region according to the position of each face region and the position of each exchanged object region, comprises:
under the condition that a distance between a position of a first face region and a position of a first exchanged object region is less than or equal to a first distance threshold, determining that the first face region is associated with the first exchanged object region,
wherein the first face region is any one of the face regions, and the first exchanged object region is any one of the exchanged object regions.

5. The method according to claim 1, wherein the human-related target regions comprise face regions and body regions, and the game-related target regions comprise exchanged object regions;
detecting the image to be processed to determine the multiple target regions in the image to be processed and the categories of the multiple target regions comprises:
detecting the image to be processed to determine the face regions, the body regions, and the exchanged object regions in the image to be processed;
performing the target recognition on the multiple target regions respectively according to the categories of the multiple target regions, to obtain the recognition results of the multiple target regions, comprises:
performing face key point extraction on the face region, to obtain face key point information of the face region;
determining human identity information corresponding to the face region according to the face key point information; and
performing body key point extraction on the body region, to obtain body key point information of the body region; and
determining the association information among the target regions according to the position and/or recognition result of each target region, comprises:
determining the face region associated with each body region according to the face key point information of each face region and the body key point information of each body region;
determining respectively human identity information corresponding to the body region associated with each face region according to the human identity information corresponding to each face region;
determining the body region associated with each exchanged object region according to the position of each body region and the position of each exchanged object region; and
determining respectively human identity information corresponding to the exchanged object region associated with each body region according to the human identity information corresponding to each body region.

6. The method according to claim 5, wherein determining the body region associated with each exchanged object region according to the position of each body region and the position of each exchanged object region, comprises:
under the condition that a distance between a position of a first body region and a position of a second exchanged object region is less than or equal to a second distance threshold, determining that the first body region is associated with the second exchanged object region,
wherein the first body region is any one of the body regions, and the second exchanged object region is any one of the exchanged object regions.

7. The method according to claim 1, wherein the human-related target regions comprise face regions and hand regions, and the game-related target regions comprise exchanged object regions;
detecting the image to be processed to determine the multiple target regions in the image to be processed and the categories of the multiple target regions comprises:
detecting the image to be processed to determine the face regions, the hand regions, and the exchanged object regions in the image to be processed;
performing the target recognition on the multiple target regions respectively according to the categories of the multiple target regions, to obtain the recognition results of the multiple target regions, comprises:
performing face key point extraction on the face region, to obtain face key point information of the face region; and
determining human identity information corresponding to the face region according to the face key point information; and
determining the association information among the target regions according to the position and/or recognition result of each target region, comprises:
determining the hand region associated with each face region according to the position of each face region and the position of each hand region;
determining respectively human identity information corresponding to the hand region associated with each face region according to the human identity information corresponding to each face region;
determining the exchanged object region associated with each hand region according to the position of each hand region and the position of each exchanged object region; and
determining respectively human identity information corresponding to the exchanged object region associated with each hand region according to the human identity information corresponding to each hand region.

8. The method according to claim 7, wherein determining the hand region associated with each face region according to the position of each face region and the position of each hand region, comprises:
under the condition that a distance between a position of a second face region and a position of a first hand region is less than or equal to a third distance threshold, determining that the second face region is associated with the first hand region,
wherein the second face region is any one of the face regions, and the first hand region is any one of the hand regions.

9. The method according to claim 1, wherein the human-related target regions comprise face regions, body regions, and hand regions, and the game-related target regions comprise exchanged object regions;
detecting the image to be processed to determine the multiple target regions in the image to be processed and the categories of the multiple target regions comprises:
detecting the image to be processed to determine the face regions, the body regions, the hand regions, and the exchanged object regions in the image to be processed;
performing the target recognition on the multiple target regions respectively according to the categories of the multiple target regions, to obtain the recognition results of the multiple target regions, comprises:
performing face key point extraction on the face region, to obtain face key point information of the face region;
determining human identity information corresponding to the face region according to the face key point information;
performing body key point extraction on the body region, to obtain body key point information of the body region; and
performing hand key point extraction on the hand region, to obtain hand key point information of the hand region; and
determining the association information among the target regions according to the position and/or recognition result of each target region, comprises:
determining the face region associated with each body region according to the face key point information of each face region and the body key point information of each body region;
determining respectively human identity information corresponding to the body region associated with each face region according to the human identity information corresponding to each face region;
determining the body region associated with each hand region according to the body key point information of each body region and the hand key point information of each hand region;
determining respectively human identity information corresponding to the hand region associated with each body region according to the human identity information corresponding to each body region;
determining the exchanged object region associated with each hand region according to the position of each hand region and the position of each exchanged object region; and
determining respectively human identity information corresponding to the exchanged object region associated with each hand region according to the human identity information corresponding to each hand region.

10. The method according to claim 5, wherein determining the face region associated with each body region according to the face key point information of each face region and the body key point information of each body region, comprises:
under the condition that an area of an overlapped region between a region where the face key point information of a third face region is located and a region where the body key point information of a second body region is located is greater than or equal to a first area threshold, determining that the third face region is associated with the second body region,
wherein the third face region is any one of the face regions, and the second body region is any one of the body regions.

11. The method according to claim 9, wherein determining the face region associated with each body region according to the face key point information of each face region and the body key point information of each body region, comprises:
under the condition that an area of an overlapped region between a region where the face key point information of a third face region is located and a region where the body key point information of a second body region is located is greater than or equal to a first area threshold, determining that the third face region is associated with the second body region,
wherein the third face region is any one of the face regions, and the second body region is any one of the body regions.

12. The method according to claim 9, wherein determining the body region associated with each hand region according to the body key point information of each body region and the hand key point information of each hand region, comprises:
under the condition that body key point information of a third body region and hand key point information of a second hand region meet a preset condition, determining that the third body region is associated with the second hand region,
wherein the third body region is any one of the body regions, and the second hand region is any one of the hand regions,
the preset condition comprises at least one of:
an area of an overlapped region between a region where the body key point information of the third body region is located and a region where the hand key point information of the second hand region is located is greater than or equal to a second area threshold;
a distance between a region where the body key point information of the third body region is located and a region where the hand key point information of the second hand region is located is less than or equal to a fourth distance threshold; and
an included angle between a first connection line of the body key point information of the third body region and a second connection line of the hand key point information of the second hand region is less than or equal to an included angle threshold,
wherein the first connection line is a connection line between an elbow key point and a hand key point in the body key point information of the third body region, and the second connection line is a connection line between hand key points in the hand key point information of the second hand region.

13. The method according to claim 7, wherein determining the exchanged object region associated with each hand region according to the position of each hand region and the position of each exchanged object region, comprises:
under the condition that a distance between a third hand region and a third exchanged object region is less than or equal to a fifth distance threshold, determining that the third hand region is associated with the third exchanged object region,
wherein the third hand region is any one of the hand regions, and the third exchanged object region is any one of the exchanged object regions.

14. The method according to claim 3, wherein the game-related target regions further comprise exchanging object regions;
detecting the image to be processed to determine the multiple target regions in the image to be processed and the categories of the multiple target regions comprises:
detecting the image to be processed to determine the exchanged object regions and the exchanging object regions in the image to be processed;
performing the target recognition on the multiple target regions respectively according to the categories of the multiple target regions, to obtain the recognition results of the multiple target regions, comprises:
performing exchanged object recognition and classification on the exchanged object regions to obtain the position and category of each exchanged object in the exchanged object regions; and
performing exchanging object recognition and classification on the exchanging object regions to obtain the category of each exchanging object in the exchanging object regions;
wherein the method further comprises:
during an exchanging time period, according to category of each exchanging object in the exchanging object regions, determining a first total value of the exchanging objects in the exchanging object regions;
during the exchanging time period, according to the position and category of each exchanged object in the exchanged object regions, determining a second total value of the exchanged objects in the exchanged object regions; and
sending a second prompt message under the condition that the first total value is different from the second total value.

15. The method according to claim 3, wherein the game-related target regions further comprise game playing regions,
detecting the image to be processed to determine the multiple target regions in the image to be processed and the categories of the multiple target regions comprises:
detecting the image to be processed, to determine the game playing regions in the image to be processed; and
performing the target recognition on the multiple target regions respectively according to the categories of the multiple target regions, to obtain the recognition results of the multiple target regions, comprises:
performing card recognition and classification on the game playing regions, to obtain the position and category of each card in the game playing regions.

16. The method according to claim 15, further comprising:
during a card dealing stage, under the condition that the category of each card in the game playing regions is different from a preset category, sending a third prompt message.

17. The method according to claim 15, further comprising:
during a card dealing stage, under the condition that the position and category of each card in the game playing regions are different from a preset position and a present rule, sending a fourth prompt message.

18. The method according to claim 15, wherein the method further comprises:
during a settling stage, according to the category of each card in the game playing regions, determining a game result;
determining a personal settling rule according to the game result and the position of each personal-related exchanged object region; and
determining each personal settling value according to each personal settling rule and a value of the exchanged object in each personal-related exchanged object region.

19. An electronic device, comprising:
a processor; and
a memory configured to store processor-executable instructions,
wherein the processor is configured to:
detect an image to be processed to determine multiple target regions in the image to be processed and categories of the multiple target regions, the image to be processed at least comprising a part of a human body and a part of an image on a game table, and the multiple target regions comprising human-related target regions and game-related target regions;
perform target recognition on the multiple target regions respectively according to the categories of the multiple target regions, to obtain recognition results of the multiple target regions; and
determine association information among the target regions according to the position and/or recognition result of each target region.

20. A non-transitory computer readable storage medium having computer program instructions stored thereon, wherein when the computer program instructions are executed by a processor, the processor is configured to:
detect an image to be processed to determine multiple target regions in the image to be processed and categories of the multiple target regions, the image to be processed at least comprising a part of a human body and a part of an image on a game table, and the multiple target regions comprising human-related target regions and game-related target regions;
perform target recognition on the multiple target regions respectively according to the categories of the multiple target regions, to obtain recognition results of the multiple target regions; and
determine association information among the target regions according to the position and/or recognition result of each target region.
